(19) United States
(12) Patent Application Publication
(10) Pub. No.: US 2024/0251415 A1
(43) Pub. Date: Jul. 25, 2024

(54) METHODS FOR UPLINK TRANSMISSION, RELATED WIRELESS DEVICES AND RELATED NETWORK NODES

(71) Applicant: Sony Group Corporation, Tokyo (JP)

(72) Inventors: Peter ISBERG, Lund (SE); Rickard LJUNG, Helsingborg (SE); Ola CEDELL, Malmö (SE); Rui NUNES, Lund (SE); Adnan PRLJA, Malmö (SE)

(21) Appl. No.: 18/290,529

(22) PCT Filed: May 11, 2022
(86) PCT No.: PCT/EP2022/062787

§ 371 Date: Nov. 14, 2023

(30) Foreign Application Priority Data
Jun. 11, 2021 (SE) 2150751-2

(51) Int. Cl. H04W 72/21

(52) U.S. Cl. CPC H04W 72/21

(57) ABSTRACT

A method is disclosed, performed by a wireless device, for uplink transmission of a data burst to a network node. The method comprises transmitting, to the network node, information indicative of a burst type. The method comprises receiving, from the network node, control signalling indicative of an allocation of a configured resource for uplink transmission.

### TECHNICAL FIELD

The present disclosure pertains to the field of wireless communications. The present disclosure relates to methods for uplink transmission, related wireless devices and related network nodes.

### BACKGROUND

In practical testing of uplink data transmission (such as uplink video transmission) over 5th generation mobile network, 5G, it has been noted that the latency sometimes exceeds expected values. Before the cell reaches its maximum capacity, some packets wait a long time before they are transmitted to the network node (such as gNB).

It has also been noted that with bursty traffic, allocation of resources can get out of synchronization with the uplink traffic pattern.

There is thus a need for improvement of the support to uplink data transmission.

### SUMMARY

The latency issue may be due to radio access network, RAN, scheduling that in certain cases allocates more uplink resources to wireless devices (such as User Equipment, UEs) currently active with data transmissions, than the wireless devices have requested. Resources allocated to one wireless device are not available to any other wireless device in the cell. Hence, over-allocating resources to a wireless device blocks resources for other wireless devices and leads to longer delays in accessing a resource for the other wireless devices within the cell.

Further, certain legacy configured grants for radio transmission do not allow for link adaptation and are hard to optimize for all radio conditions. The legacy configured grants are not adapted to transmissions of data bursts.

Accordingly, there is a need for devices and methods for uplink transmission, which may mitigate, alleviate or address the shortcomings existing and may provide an improvement of configured grants to be more adaptive to bursty traffic.

A method is disclosed, performed by a wireless device, for uplink transmission of a data burst to a network node. The data burst may comprise a plurality of data packets. The method comprises transmitting, to the network node, information indicative of a burst type. The method comprises receiving, from the network node, control signalling indicative of an allocation of a configured resource for uplink transmission.

Further, a wireless device is provided. The wireless device comprises memory circuitry, processor circuitry, and a wireless interface. The processor circuitry is configured to transmit, to a network node, information indicative of a burst type. The processor circuitry is configured to receive, from the network node, control signalling indicative of an allocation of a configured resource for uplink transmission.

It is an advantage of the present disclosure that the allocation of configured resources in time and frequency for data bursts is improved. For example the configured grant for pre-allocation of time and frequency resources of periodic uplink data transfer is improved for the support of data bursts. These improvements aim at minimizing delay, by pre-allocating resources synchronized with an application, and minimize overallocation, by signalling the actual burst size. The disclosed enhancements provide signalling to support variations in data sizes (such as variations in the required amount of resource allocations) and in timing for data bursts exhibiting a repeated transmit pattern. Further, the indication of data burst type provides a possibility to prioritize certain data bursts over fewer other data bursts.

A method is disclosed, performed by a network node, for resource allocation of a data burst in uplink transmission from a wireless device. The data burst may comprise a plurality of data packets. The method comprises receiving, from the wireless device, information indicative of a burst type. The method comprises transmitting, to the wireless device, based on the information, control signalling indicative of an allocation of a configured resource for uplink transmission.

Further, a network node is provided, the network node comprising memory circuitry, processor circuitry, and a wireless interface. The processor circuitry is configured to receive, from a wireless device, information indicative of a burst type. The processor circuitry is configured to transmit, to the wireless device, based on the information, control signalling indicative of an allocation of a configured resource for uplink transmission.

The disclosed network node and related method provide an improvement of allocation of configured resources in time and frequency for data bursts. The disclosed network node and related method permit adaptation to changing radio conditions and/or traffic conditions via signalling indicative of burst types. The disclosed network node and related method permit resource allocation of data burst patterns using a small amount of control signalling overhead.

A method is disclosed, performed by a wireless device, for uplink transmission of a data burst to a network node. The data burst may comprise a plurality of data packets. The method comprises transmitting, to the network node, control information indicative of a time adjustment parameter for adjusting a timing of an allocation of a configured resource at the network node.

Further, a wireless device is provided. The wireless device comprises memory circuitry, processor circuitry, and a wireless interface. The processor circuitry is configured to transmit, to a network node, control information indicative of a time adjustment parameter for adjusting a timing of an allocation of a configured resource at the network node.

Advantageously, the disclosed wireless device provides various methods to support timing adjustments for configured resources, such as for pre-configured uplink grants.

A method is disclosed, performed by a network node, for resource allocation of a data burst in uplink transmission from a wireless device. The data burst may comprise a plurality of data packets. The method comprises receiving, from the wireless device, control information indicative of a time adjustment parameter for adjusting, at the network node, a timing of an allocation of a configured resource. The configured resource is for the uplink transmission of the data burst. The method comprises adjusting, based on the control information, the timing of the allocation of the configured resource.

Further, a network node is provided. The network node comprises memory circuitry, processor circuitry, and a wireless interface. The processor circuitry is configured to receive, from a wireless device, control information indicative of a time adjustment parameter for adjusting, at the network node, a timing of an allocation of a configured resource. The configured resource is for the uplink transmission of the data burst. The processor circuitry is configured to adjust, based on the control information, the timing of the allocation of the configured resource.

Advantageously, the disclosed network node supports timing adjustments for configured resources, such as for pre-configured uplink grants. This may reduce latency since the timing of the radio resource can be optimized to the availability of the data burst(s) to be transmitted.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a schematic diagram illustrating an example timing for configured grant,

FIGS. 3A-B are schematic diagrams illustrating an example configured grant pattern that can accommodate for data bursts according to this disclosure and an example time adjusted configured grant pattern according to this disclosure,

FIG. 4 is signalling diagram illustrating an example communication between an example wireless device and an example network node according to this disclosure,

FIG. 5 is a flow-chart illustrating an example method, performed in a wireless device, for an uplink transmission to a network node according to this disclosure,

FIG. 6 is a flow-chart illustrating an example method, performed in a network node of a wireless communication system, for resource allocation of a data burst in uplink transmission from a wireless device according to this disclosure,

FIG. 7 is a flow-chart illustrating an example method, performed in a wireless device, for an uplink transmission to a network node according to this disclosure,

FIG. 8 is a flow-chart illustrating an example method, performed in a network node of a wireless communication system, for resource allocation of a data burst in uplink transmission from a wireless device according to this disclosure,

FIG. 9 is a block diagram illustrating an example wireless device according to this disclosure,

FIG. 10 is a block diagram illustrating an example network node according to this disclosure,

FIG. 11 is a block diagram illustrating an example wireless device according to this disclosure,

FIG. 12 is a block diagram illustrating an example network node according to this disclosure,

FIGS. 13A-E are signalling diagrams illustrating example communications between an example wireless device and an example network node according to this disclosure,

FIG. 14 is a schematic diagram illustrating example configured grant patterns for time adjustment according to this disclosure, and

FIGS. 15A-B are signalling diagrams illustrating example communications between an example wireless device and an example network node according to this disclosure.

### DETAILED DESCRIPTION

Various examples and details are described hereinafter, with reference to the FIGS. when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

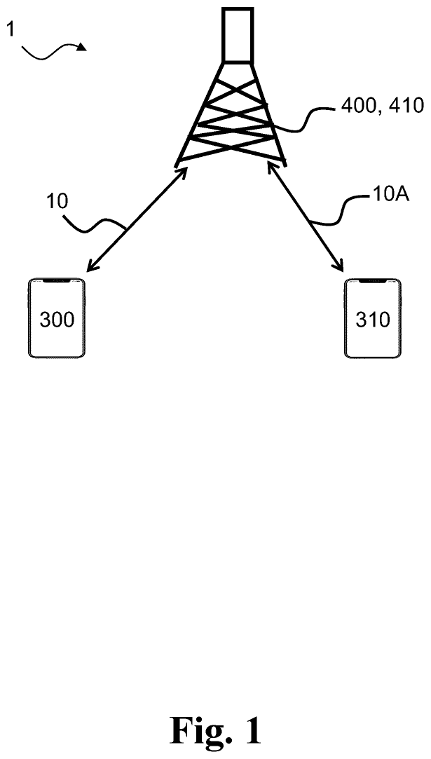

FIG. 1 is a diagram illustrating an example wireless communication system 1 comprising an example network node 400, 410 and an example wireless device 300 according to this disclosure.

As discussed in detail herein, the present disclosure relates to a wireless communication system 1 comprising a cellular system, for example, a 3^{rd} Generation Partnership Project, 3GPP, wireless communication system, such as a 5G system. The wireless communication system 1 comprises a wireless device 300 and/or a network node 400, 410.

A network node disclosed herein refers to a radio access network, RAN, node operating in the radio access network, such as a base station, an evolved Node B, eNB, gNB in NR. In one or more examples, the RAN node is a functional unit which may be distributed in several physical units.

The wireless communication system 1 may comprise a core network node. A core network, CN, node may be seen a network node operating in the core network, such as in the Evolved Packet Core Network, EPC, and/or a 5G Core Network, 5GC. Examples of CN nodes in EPC include a Mobility Management Entity, MME.

The wireless communication system 1 described herein may comprise one or more wireless devices 300, 310, and/or one or more network nodes 400, 410, such as one or more of: a base station, an eNB, a gNB and/or an access point.

A wireless device may refer to a mobile device and/or user equipment, UE.

The wireless device 300, 310 may be configured to communicate with the network node 400, 410 via respective wireless links (or radio access link) 10, 10A.

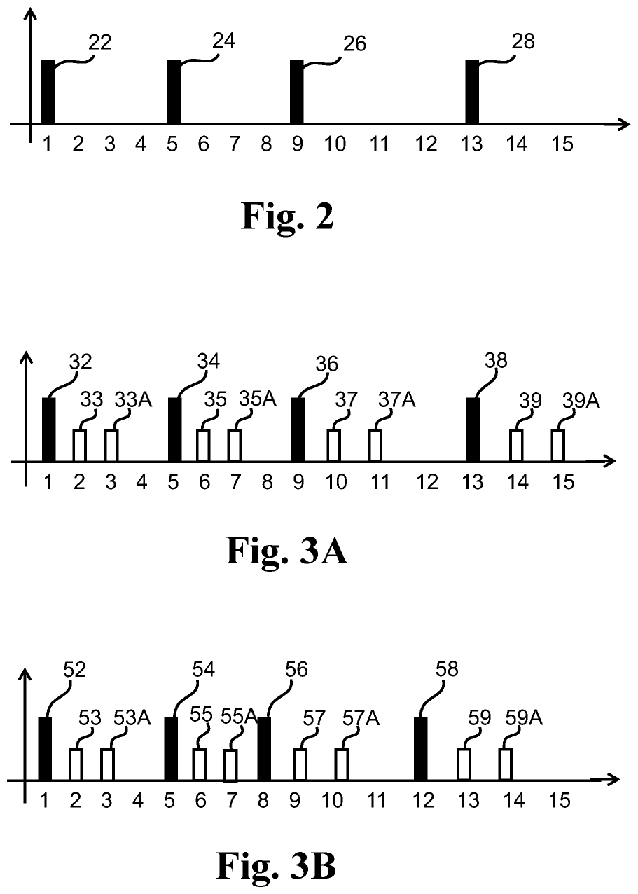

FIG. 2 shows a schematic diagram illustrating an example timing for configured grant. FIG. 2 illustrates an example of a configured grant pattern without data burst, and seen from an application layer view.

The vertical axis indicates data size, and the horizontal axis indicates time units. As shown in FIG. 2, data packets 22, 24, 26, 28 are allocated to time slots 1, 5, 9, and 13 respectively, with no data packets being allocated during the other time units. Therefore, FIG. 2 illustrates a periodicity of the configured grant for transmission of the data packets 22, 24, 26, 28, with no bursty traffic. In other words, FIG. 2 illustrates a configured grant pattern that does not accommodate for a data burst, such as data transmissions exhibiting a bursty behaviour.

A data burst may be seen as a set of data packets, that for example belong to the same group. The set of data packets of the data burst may comprise one or more data packets, for example associated with a same group of data packets. In some examples, the data burst can comprise a single large packet (for examples larger than 1.5 KBytes). In some examples, the data burst can comprise a plurality of data packets. Data bursts may vary in size but exhibit a pattern in time (such as a periodicity) and/or in size and/or in priority. For example, a data burst may be seen as a packet group with a relation between data packets belonging to the packet group. For example, a data burst comprises related data packets, such as data packets related to each other. For example, the relation between data packets within a group may be defined on an application layer, or on IP protocol layer, or a layer different than a physical layer or a layer different than a transport layer. A data burst may be seen as a burst of data packets, such as forming a group, such as part of a frame, such as a part of video frame. A group of data packets may be seen as a group of data units, such as a group of consecutive data packets, for example consecutive data packets with a shorter inter-packet gaps. Data bursts may exhibit a pattern in transmissions, such as a pattern in size, and/or in time, such as in repetition, etc. Data traffic may exhibit a data burst pattern. A data burst pattern may consist of two or more data bursts, wherein the pattern may determine one or more characteristics defining the inter-relation between the two or more data bursts. A data burst pattern may define a difference in data burst size between different data bursts. A data burst pattern may define an order of data bursts of different characteristics. A data burst pattern may define time delays between two or more data bursts. As an example a data burst pattern may define combinations of different size of data bursts, their individual order of required transmission, and their individual expected timing of required transmission. As a further example, a data burst pattern may define the individual order of different data sizes of data bursts, while not defining the individual timing between the data bursts. Some traffic types, such as video and audio, have a prominent data pattern over time that is characteristic of a data burst since encoders produce a certain number of frames per second. For example, with video using for example H.264 or H.265 codecs, there are I, P and B frames where the I frame is the largest in size and also most important as it constitutes the baseline for several frames (in Group of Pictures, GOP structure). There may be a pattern in terms of regularly producing a large I-frame followed by smaller P/B frames. For example, the data burst pattern may be related to data stream of P-frames, for example with pattern in terms of periodicity and/or size and/or priority. A data burst pattern may arise from various use cases where different data bursts are created, including but not limited to gaming, industrial wireless sensors, connected cars, health care and/or music playback/recording.

Data bursts can lead to over-allocating resources to a wireless device. Over-allocating resources to a wireless device (such as wireless device 300 of FIG. 1) blocks resources for other wireless devices and may lead to longer delays in accessing resource for the other wireless devices. For example, some allocated resources may be likely not to be utilized for meaningful data but to be filled with padding data. The result may be that the wireless device (such as wireless device 300 of FIG. 1) which receives over-allocation of resources is given very good opportunities to transmit its data, while other wireless devices not yet scheduled will experience longer delays when requesting resources for transmissions. The present disclosure can reduce the likelihood of over-allocating resources by improving the configured grant mechanism for data bursts.

With bursty traffic, the allocation of resources can get out of synchronization with the traffic pattern. For example, the amount of data to be transmitted increases every time an I-frame appears, and the allocation of resources has to be increased accordingly. For example, a short time later, the I-frame is fully transmitted, and the allocation to the specific wireless device could quickly be decreased to free up resources for other wireless devices in the cell. However, the network node may likely be a step behind and may not stay fully in synchronization with the traffic pattern, thereby resulting in wasted resources. For example, 2-5 ms delay from requesting a resource until a grant is received has been observed. The disclosed technique addresses, inter alia, this challenge and provides an improved support for bursty traffic.

For example, in an uplink video streaming for professional production, the data rates may be high (for production quality) and the latency can be critical (for example, due to using a mix of wired and wireless cameras that should stay in synchronization, and/or due to the need of round-trip feedback to camera operators). The present disclosure provides a technique that allows the network node to be aware in advance of the traffic pattern so that grants can be provided proactively, via the use of an improved configured grant.

The present disclosure provides a technique for improving the use of configured grants for bursty traffic (such as video streaming) by signalling information indicative of a burst type. A burst type may be seen as a type of data burst, such as a category of data burst. A burst type may be associated with (for example, indicative of) a pattern (which may be referred to as data burst pattern herein) of transmissions of the data burst or a range of patterns of transmissions of the data burst. A burst type may be indicative of a pattern of transmissions of the data burst and/or a range of patterns of transmissions of the data burst. A pattern of transmissions of a data burst may be seen as a data burst pattern. In one or more examples, a burst type may include a data size information, such as size information. In one or more examples, a burst type may include priority information, wherein the priority information may relate to relative priority between data bursts. A data burst pattern may be seen as a repetition of transmissions in time with variation in sizes of data bursts. The data burst to be transmitted by the wireless device may correspond to a burst type, based on its data burst pattern. For example, I-frames may be part of a burst type that is different from the burst type for P-frames and/or B-frames. The present disclosure provides a technique for communicating data burst pattern aspects between a wireless device and a network node.

FIGS. 3A-B show schematic diagrams illustrating an example configured grant pattern that can accommodate for data bursts according to this disclosure. A configured grant pattern may be constituted of resource allocations by the network node, e.g. time and/or frequency allocations for the respective grants within the pattern. A configured grant pattern according to this disclosure may be seen as a grant pattern aimed at fitting well with a data burst pattern.

The configured grant pattern may be based on timings and expected amounts of data or data burst(s) to be transmitted by a wireless device. In other words, the network node may allocate a configured grant based on expected amounts of data or data burst(s) at certain time instances, from an upper layer, such as application layer.

The vertical axis indicates data size of the grants within the grant pattern, and the horizontal axis indicates time units. FIG. 3A shows data bursts 32, 34, 36, 38 allocated to time units 1, 5, 9, and 13 respectively, and data bursts 33, 33A, 35, 35A, 37, 37A, 39, 39A allocated to time units 2, 3, 6, 7, 10, 11, 14, and 15 respectively. Further, there is no data burst allocated to the grants in time unit 4, 8, and 12. Data bursts 32, 34, 36, 38 respectively have a size which is larger than the respective size of data bursts 33, 33A 35, 35A, 37, 37A, 39, 39A. This is a high-level example illustration of a bursty behaviour that the configured grant has accommodated according to the disclosed technique.

Each data bursts of FIG. 3A may be allocated one or a plurality of grants for data packets, that match the amount of data illustrated.

As shown in FIG. 3A, data bursts vary in size but can exhibit a data burst pattern. In other words, two or more data bursts of FIG. 3A show a data burst pattern that can be related to size, and/or time, such as size differences and/or time differences. The illustrated data bursts may be of a burst type. The burst type disclosed herein is used to characterize a data burst pattern.

FIG. 3B shows data bursts 52, 54, 56, 58 allocated to time units 1, 5, 8, and 12 respectively, and data bursts 53, 53A, 55, 55A, 57, 57A, 59, 59A allocated to time units 2, 3, 6, 7, 9, 10, 13, and 14, respectively. Further, there is no data burst allocated within the grant in time units 4, 11, and 15. Data bursts 52, 54, 56, 58 respectively have a size which is larger than the respective size of data bursts 53, 53A 55, 55A, 57, 57A, 59, 59A. The wireless device may detect drift in time between the configured grant and the actual timing of data bursts incoming to the radio transmit buffer of the wireless device, for example from upper layers. This may imply a need to adjust a configured grant pattern, in order to better match the incoming data bursts within the wireless device to corresponding resource allocations from the network node

FIG. 3B shows a configured grant pattern with an adjusted timing to remedy the drift in time. FIG. 3B shows that, by using a time adjustment technique disclosed herein, the configured grant gets adjusted at time unit 8 of FIG. 3B for transmitting data bursts 56, 57, 57A. This shows how to remedy a drift between the resource allocation and the actual time of incoming data, e.g. data incoming from higher layers within the radio transmit buffer of the wireless device, so as to enable transmission of data bursts.

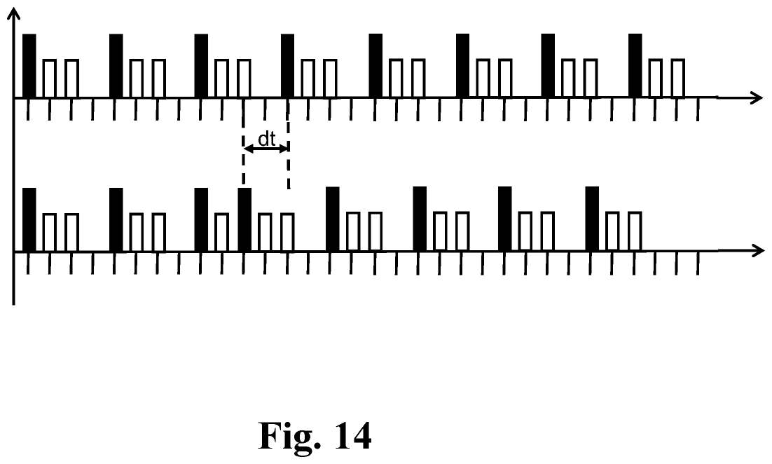

During uplink transmissions, it cannot always be guaranteed that a clock (such as media clock) at the wireless device is locked to the network clock, which may thereby cause drift and/or un-synchronizing of the data bursts being sent as compared to the resource allocation of a configured resource. For example, the media frames per second number may be derived from a production studio house clock or it may be a free-running clock in a wireless device. So, when a wireless device and a network node intend to use a certain periodicity, such as 60 frames per second (fps), some drift over time with respect to the network defined system frame periodicity may occur. As fine-adjustment of the clocks (like Phased Locked Loop, PLL) is not expected to happen, it can be advantageous to re-synchronize the grant pattern by indicating the time adjustment in the right direction, such as by “nudging” it in the right direction. For uplink transmission, the drift can be detected in the wireless device, by the offset of grants compared to the expected configured resource. The wireless device can be configured to transmit control information indicative of a time adjustment parameter, such as a nudge or nudge parameter, nudge request, time adjustment parameter request, to a particular grant, asking the network node to adjust the configured grant pattern by a certain amount (such as dt in FIG. 14).

The time adjustment parameter may also be used to reset the pattern, for example in cases where the media encoder momentarily had to adapt the encoding due to e.g. an image scene change from one frame to another. This may be done, for example, either with the timer itself or with a reset flag.

In one or more example methods, control information indicative of a time adjustment parameter can be transmitted from the wireless device to the network node to improve resource allocation by informing the network node of the drift. As shown, the disclosed time adjustment parameter is used to synchronize between the network node and the wireless device. This can advantageously improve resource allocation as less time slots are wasted in not transmitting data. The control information indicative of the time adjustment parameter may be done through physical layer (for example with Uplink Control Information, UCI) and/or via Medium Access Control layer (such as with MAC-Control Element, MAC-CE). At MAC layer, a signalling grant may be required.

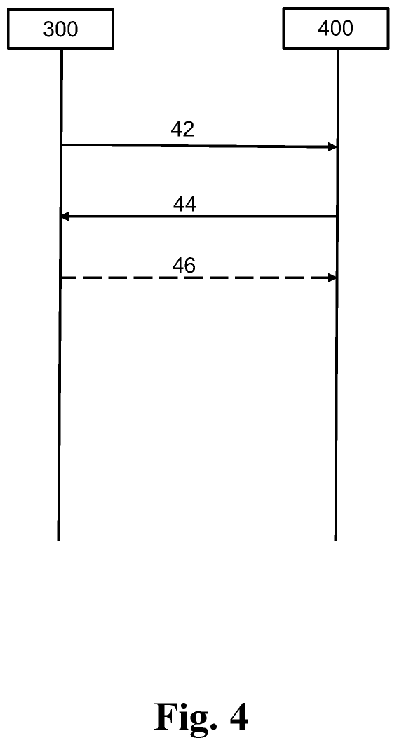

FIG. 4 is a signalling diagram illustrating an example communication between an example wireless device 300 and an example network node 400 according to this disclosure.

The wireless device 300 may predict and/or may have data for uplink transmission, such as a data burst, for example in a buffer, such as a transmit buffer. For example, the data for uplink transmission may comprise data bursts coming from an upper layer, such as a layer above physical layer, such as application layer.

The wireless device 300 is configured to transmit to the network node 400, information 42 indicative of a burst type. A burst type may be seen as a type of data burst, such as a category of data burst. The category and/or type may, in one or more examples, relate to a size of a data burst. The category and/or type may, in one or more examples, relate to a priority of a data burst. The category and/or type may in one or more examples relate to a periodicity of a data burst. A burst type may be associated with a pattern (which may be referred to data burst pattern herein) of transmissions of one or more types of data bursts or a range of patterns of transmissions of one or more types of data bursts. A data burst pattern may be seen as a repetition of transmissions in time with variation in sizes, and/or priorities of data bursts. The data burst to be transmitted by the wireless device 300 may correspond to a burst type, based on its data burst pattern.

The network node 400 may consider information 42 indicative of the burst type when performing an allocation of a configured resource for uplink transmission of the data burst.

The disclosed information 42 may lead to a more adaptive allocation, in particular for bursty traffic. For example, the disclosed technique allows utilizing the concept of configured grants as the method for resource allocation for bursty uplink data traffic where the size of a data burst may vary, but may follow a given pattern and/or where the occasion in time of each data burst is unknown.

The wireless device 300 is configured to receive, from the network node 400, control signalling 44 indicative of an allocation of a configured resource for uplink transmission. The configured resource may be a pre-configured resource, such as a configured grant of the resource, such as a pre-configured grant of the resource. For example, the configured resource may be configured using Radio Resource Control, RRC and/or physical layer signalling. For a configured grant, several parameters may be set up when a configured grant is of Type 1 or of Type 2 as provided in TS38.321, Rel-16 version 16.4.0, clause 5.8.2.

The configured grant concept in 3GPP works either with all configurations done by RRC signalling (Type 1) or with a mix of RRC and physical layer (layer 1) signalling (Type 2):
Type 1: A resource allocation pattern is configured, by RRC, with data size, repetition frequency, burst size etc.
Type 2: A resource allocation pattern is defined, but for each time it may occur the network node 400 indicates its validity with an indicator, such as a physical layer activation signal.

However, legacy configured grants Type 1 do not allow for link adaptation and are hard to optimize for all radio conditions. The legacy configured grants Type 1 and Type 2 are not adapted to transmissions of data bursts.

The wireless device 300 may be configured to transmit, to the network node 400, the data 46 using the configured resource indicated in the control signalling 44, such as using the configured grant indicated.

The present disclosure can apply to any data transmission exhibiting a bursty behaviour, such as transmission of media data, for example, for video and/or gaming and/or multimodal communications, and/or transmission of Internet of things, IOT, data (for example, sensor data collected from various sensors).

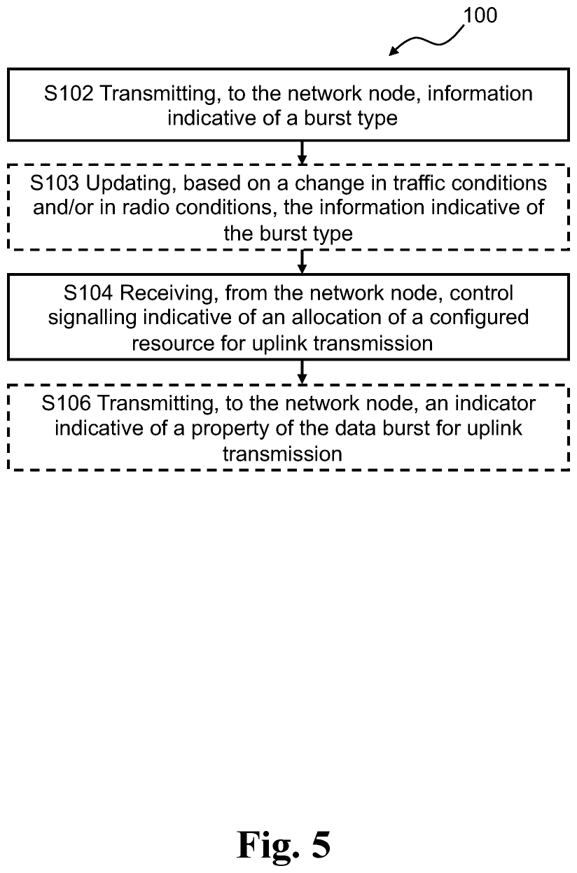

FIG. 5 shows a flow diagram of an example method 100, performed by a wireless device (such as wireless device 300 of FIGS. 1, 9, 13A-E and 15A-B) according to the disclosure, for uplink transmission of a data burst to a network node).

In one or more example methods, the data burst comprises a set of data packets. The set of data packets may comprise one or more data packets. In one or more example methods, the data burst comprises a plurality of data packets. In one or more example methods, the plurality of data packets is associated with a same group. A data burst may be seen as a plurality of data packets, that for example belong to the same group. A data burst may vary in size but can exhibit a pattern in time and/or size. For example, a data burst may be seen as a packet group with a relation between data packets belonging to the packet group. For example, a data burst comprises related data packets, such as data packets related to each other. A data burst may be seen as a burst of data packets, such as forming a group, such as part of a frame, and/or a slice of a frame or a whole frame, such as a part of video frame. A data burst may be carried by more than one transport block, such as a plurality of transport block per period. A group of data packets may be seen as a group of data units, such as a group of consecutive data packets, for example with a shorter inter-packet gaps. Data traffic can exhibit a pattern in transmissions of the data bursts, such as a pattern in size, and/or in time and/or in priority, such as in repetition, etc. Some traffic types, such as video and audio, have a prominent data burst pattern over time that is characteristic of a data burst since encoders produce a certain number of frames per second. For example, with video using for example H.264 or H.265 codecs, there are I, P and B frames where the I frame is the largest in size and also most important as it constitutes the baseline for several frames (in Group of Pictures, GOP structure). There may be a pattern in terms of regularly producing a large I-frame followed by smaller P/B frames.

The method 100 comprises transmitting S102, to the network node, information indicative of a burst type. For example the information may be indicative of one or more burst types, such as indicative of a set of burst types. A burst type may be seen as a type of data burst, such as a category of data burst. A burst type may be associated with a pattern of transmissions of the data bursts or a range of patterns of transmissions of the data bursts. A pattern may be seen as a repetition of transmissions in time with variation in sizes of data bursts. The data burst to be transmitted by the wireless device 300 may correspond to a burst type, based on its pattern. For example, burst types could be type A with a large size (such as for I frames) and type B with a smaller size (such as for P-frames). A pre-configuration of relevant resource needs can be determined by the network node to match each burst type signalled by the wireless device.

In one or more examples, the wireless device can (for example on layer 2) indicate a set of different burst types (but not time indications on when and in what order the data bursts may come). For example, the network node can preconfigure a set of grant types to match burst types. No real resource allocation may be made at this stage by the network node.

The method 100 comprises receiving S104, from the network node, control signalling indicative of an allocation of a configured resource for uplink transmission, such as for uplink transmission of a data burst. For example, the allocation of the configured resource may be a configured grant, such as preconfigured grant for uplink transmission of a data burst, such as data packets of a data burst. For example, the configured resource may be a pre-configured resource, such as a pre-configured resource grant. The control signalling may be in form of one or more control messages. The control signalling may be in form of a flag activating and/or pointing to a preconfigured grant. The control signalling can give the wireless device a permission to transmit the data burst(s) according to a configured grant pattern, such as at occasions according to the configured grant pattern. A configured grant pattern may be seen as a grant pattern configured to serve and/or match the data burst pattern.

In one or more example methods, the information indicative of the burst type comprises information indicative of a pattern in data bursts, such as between two or more data bursts. The pattern may be referred to as a data burst pattern. In one or more example methods, the information indicative of the burst type comprises information indicative of a shape of the data bursts, such as two or more data bursts, such as a structure of the data burst. A pattern may be seen as a repetition of transmissions in time with variation in sizes of data bursts and/or in priority of the data bursts. The data burst to be transmitted by the wireless device 300 may correspond to a burst type, based on its data burst pattern.

In one or more example methods, the method 100 comprises updating S103, based on a change in traffic conditions and/or in radio conditions, the information indicative of the burst type. It may be appreciated that the disclosed method allows to adapt to traffic conditions and/or radio conditions which are varying, also during a transmission of a data burst.

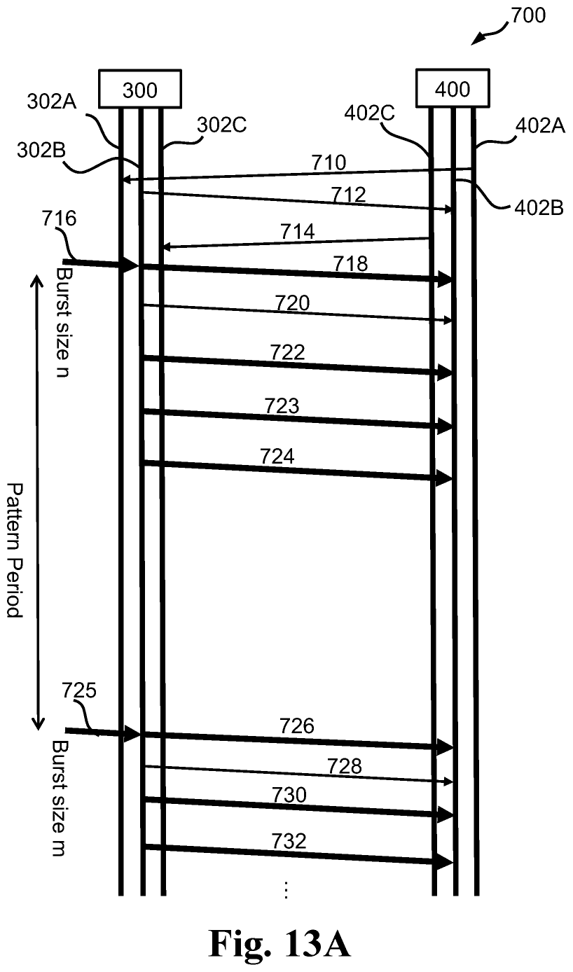

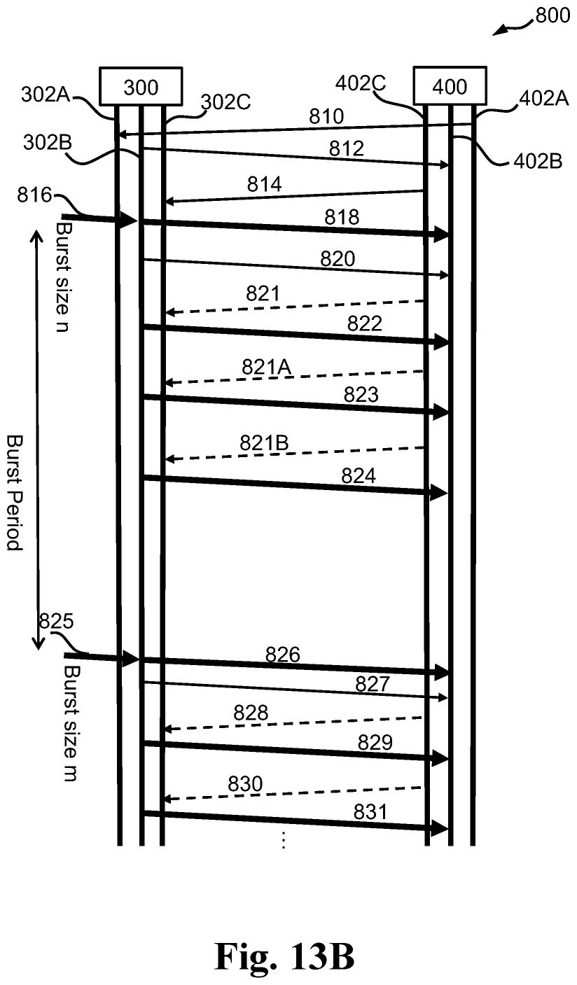

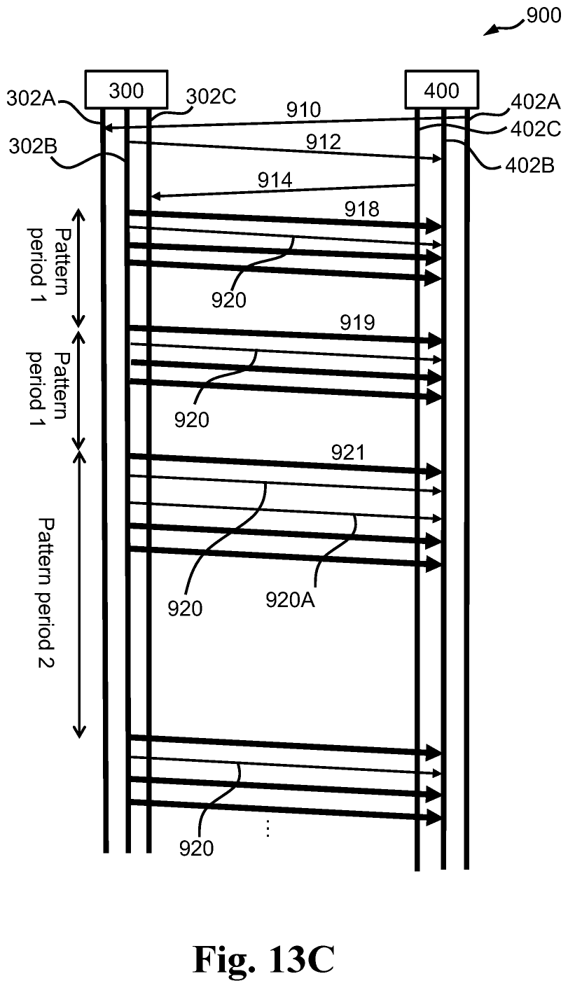

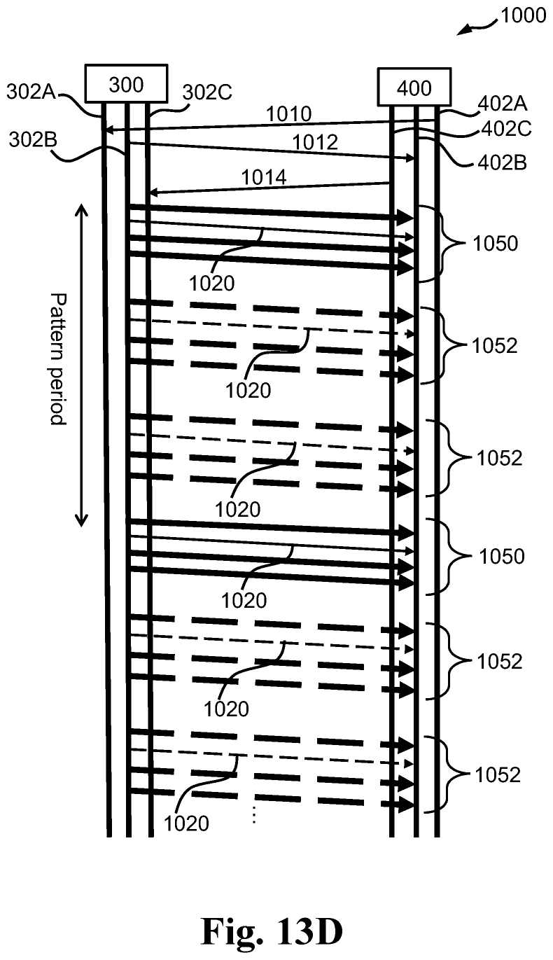

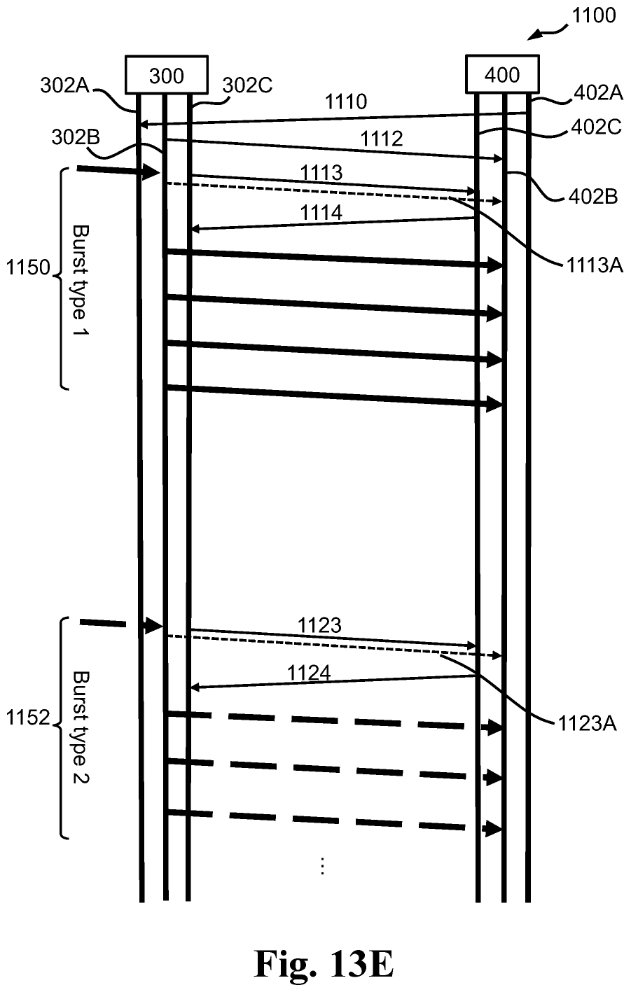

In one or more example methods, the information indicative of the burst type comprises time information related to the data burst. In one or more example methods, the time information is indicative of a periodicity of the data burst and/or of an order of the data burst. For example, the wireless device can (for example, in MAC layer) indicate a set of different burst types and their respective expected repetition pattern, and relative priority to the network node to form a repeated pattern of resource needs. The network node can preconfigure a grant for this. The pattern configuration can be updated by the wireless device (layer 2) to match the changes in the generated traffic (for example, a change of frame rate). The periodicity may be based on a period, such as a pattern period, such as a burst period as illustrated in FIGS. 13A-E. The order of the data burst may be seen as a sequence of the data burst with respect to other data bursts.

In one or more example methods, the time information is indicative of a time adjustment parameter for adjusting a timing of the allocation of the configured resource at the network node. In one or more example methods, the time information is indicative of a time adjustment parameter for the network node to adjust a timing of the allocation of the configured resource. For example, the network node receiving the information comprising the time information indicative of the time adjustment parameter can determine the allocation of the configured resource and can communicate, to the wireless device, the control signalling indicative of the determined allocation of the configured resource which is received in step S104. For example, the time adjustment parameter may be an offset. The time information may be seen as control information. The time information indicative of the time adjustment parameter can lead to change of burst type, for example, to pattern reconfiguration at the network node.

In one or more example methods, the information indicative of the burst type comprises size information of the data burst. In one or more example methods, the size information of the data burst comprises a statistical parameter indicative of a size of the data burst. For example, the statistical parameter indicative of the size of the data burst is indicative of one or more of: a peak of the size, a mean of the size, and a mean with a margin for the size. A margin may be given a margin value, such as a value and/or a percentage. A margin may be derived based on a standard deviation (for example, k*SD where k is a constant and SD is the standard deviation). The margin may be derived based on the peak and mean values. In one or more example methods, the size information of the data burst comprises a statistical parameter indicative of a change in the size of the data burst. For example, a statistical parameter indicative of a change in the size may comprise a deviation in size of the current and/or ongoing burst from the (pre-) indicated size in burst types. For example, the information indicative of burst type may point or provide information of the peak (and/or mean and/or margin) burst size in the indicated burst type(s). For example, a peak value guarantees that enough resources are allocated by the network node. The network node can predict, based on the information on burst type, the ending of a data burst more precisely and minimize overscheduling and/or over-allocating resources. To optimize and handle the natural deviation of burst size, the wireless device can indicate in layer 2 a deviation in size of the current and/or ongoing burst from the (pre-) indicated size in burst type information.

In one or more example methods, the information indicative of the burst type comprises priority information between burst types. In one or more example methods, the information indicative of the burst type comprises priority information between data packets. The priority information may be seen as indicative of a priority between data burst types and/or data packets, such as a relative priority of a burst type with respect to other burst types. For example, a burst type may be prioritized over other burst types. For example, a data burst for I frames may be indicated by a burst type having higher priority than burst type for P or B frames. Priority information is illustrated in part in FIG. 13E.

In one or more example methods, the method 100 comprises transmitting S106, to the network node, an indicator indicative of a property of the data burst for uplink transmission. For example, the property may comprise a type of data burst, and/or an actual size of the data burst (such as a peak of the size, a maximum size, a mean of the size, and/or a margin of size). The indicator is illustrated as indicator 720, 820, 920, 1020 of FIGS. 13A-D, such as MAC-CE. This indicator may lead to a change of burst type at the network node (as illustrated in FIG. 13C). In one or more examples, the wireless device can (for example on layer 2) indicate a set of different burst types (but not time indications on when and in what order the data bursts may come). For example, the wireless device can indicate a set of different burst types within a procedure for initiating and/or adjusting a configured grant allocation at the network side. For example, the wireless device can indicate a set of different expected burst types based on the type of data bursts and/or data traffic that the wireless device expects to transfer in an upcoming data session. For example, the network node can utilize information indicative of a set of burst types to preconfigure a set of grant types to match the burst types. In one or more examples, no real resource allocation may be made at this stage by the network node. In one or more examples, at least a subset of information relating to potential future resource allocation(s) may be provided by the network node to the wireless device as a result of the configuring of one or more preconfigured grant types at the network node. Such subset of information may include but is not limited to modulation formats, frequency ranges, bandwidth part information, coding formats, timing information, antenna configurations and/or beam configurations. The at least subset of information may be used by the wireless device later, if such specific grant type is to be allocated. A pointer and/or marker to a certain grant type allocation information may be utilized in the signalling between the wireless device and the network node, to support indication of a specific grant type with small amount of signalling (such as a flag). As an example, a numbering scheme can be used, and signalled with a bit pattern. As an example, two different grant types can be pointed towards with a single indicator bit, where one grant type is indicated by a “0” and a second grant type is indicated by a “1”. With more indicator bits, additional grant types can be signalled, e.g. 4 different types can be signalled with two bits, etc. The definition of a grant type pointer may be communicated by the network node to the wireless device in conjunction with the transmission of the at least subset of information relating to potential future resource allocation for the grant type. When a data burst is obtained by the wireless device from upper layers, the wireless device can then (in layer 1 and/or layer 2) send an indicator (such as a quick indicator) informing of what type of data burst is in the buffer or is about to be available in the buffer of the wireless device, and then the network node can immediately allocate corresponding resources to the wireless device, for example using the preconfigured set of grant types. In one or more examples wherein the network has provided resource grant information to the wireless device in advance, the corresponding allocation to match the upcoming burst type can be provided by the network node to the wireless device with small amount of signalling load by referring to the earlier transmitted information related to the resource allocation (for example, using a flag).

In one or more example methods, control signalling indicative of the allocation of the configured resource for uplink transmission is based on the burst type. For example, the network node can take into account the information indicative of burst type to perform allocation of configured resource and provide possibly a configured grant for a burst type. In one or more example methods, the control signalling indicative of the allocation of the configured resource for uplink transmission comprises control signalling indicative of a configured grant. For example, in a dynamic scheduling approach (as described in FIG. 13B), the pre-configured grant would apply to the 1st uplink data packet transmission.

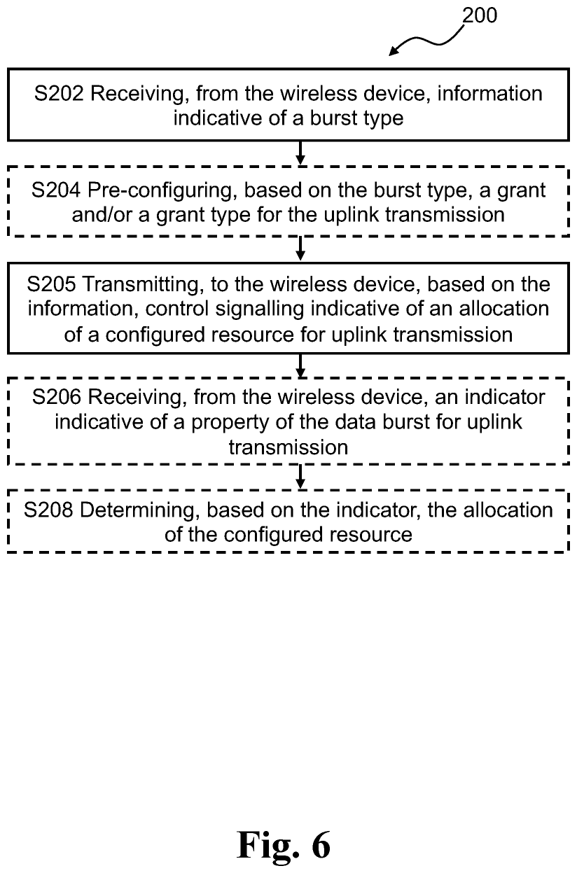

FIG. 6 shows a flow diagram of an example method 200, performed by a network node (such as network node 400 of FIGS. 1, 2, 10, 12, 13A-E and 15A-B) according to the disclosure, for resource allocation of a data burst in uplink transmission from a wireless device.

In one or more example methods, the data burst comprises one or more data packets. In one or more example methods, the data burst comprises a plurality of data packets. In one or more example methods, the plurality of data packets is associated with a same group.

The method 200 comprises receiving S202, from the wireless device, information indicative of a burst type. The information received in S202 may be transmitted in S102 of FIG. 5.

The method 200 comprises transmitting S205, to the wireless device, based on the information, control signalling indicative of an allocation of a configured resource for uplink transmission.

In one or more example methods, the method 200 comprises pre-configuring S204, based on the burst type, a grant and/or a grant type for the uplink transmission. For example, the network node can take into account the information indicative of burst type to perform allocation of configured resource and provide possible a configured grant for a burst type. For example, the network node can preconfigure a set of grant types to match burst types.

No real resource allocation may be made at this stage by the network node. When a data burst is obtained by the wireless device from upper layers, the wireless device can then (in layer 1/layer 2) send an indicator (such as a quick indicator) informing of what type of data burst is in the buffer of the wireless device, and then the network node can immediately allocate corresponding resources to the wireless device, for example using the preconfigured set of grant types.

In one or more example methods, control signalling indicative of the allocation of the configured resource for uplink transmission comprises control signalling indicative of a pre-configured grant.

In one or more example methods, the information indicative of the burst type comprises information indicative of a pattern in data bursts and/or of a shape of the data bursts.

In one or more example methods, the information indicative of the burst type comprises time information related to the data burst(s). In one or more example methods, the time information is indicative of a periodicity of the data burst and/or of an order of the data burst.

In one or more example methods, the time information is indicative of a time adjustment parameter for adjusting a timing of the allocation of the configured resource at the network node.

In one or more example methods, the information indicative of the burst type comprises size information of the data burst. In one or more example methods, the information indicative of the burst type comprises priority information between burst types. In one or more example methods, the information indicative of the burst type comprises priority information between data packets.

In one or more example methods, the method 200 comprises receiving S206, from the wireless device, an indicator indicative of a property of the data burst for uplink transmission. For example, the indicator may have been transmitted at S106 of FIG. 5.

In one or more example methods, the method 200 comprises determining S208, based on the indicator, the allocation of the configured resource. For example, the network node may update based on the indicator, the allocation of the configured resource.

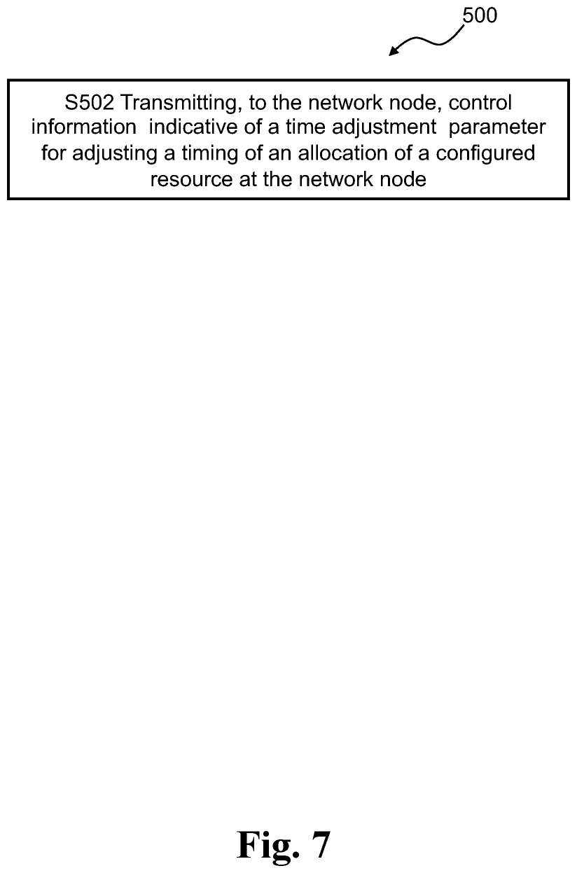

FIG. 7 shows a flow diagram of an example method 500, performed by a wireless device (such as wireless device 310 disclosed herein) according to the disclosure, for uplink transmission of a data burst to a network node.

In one or more example methods, the data burst comprises one or more data packets. In one or more example methods, the data burst comprises a plurality of data packets, for example associated with a same group.

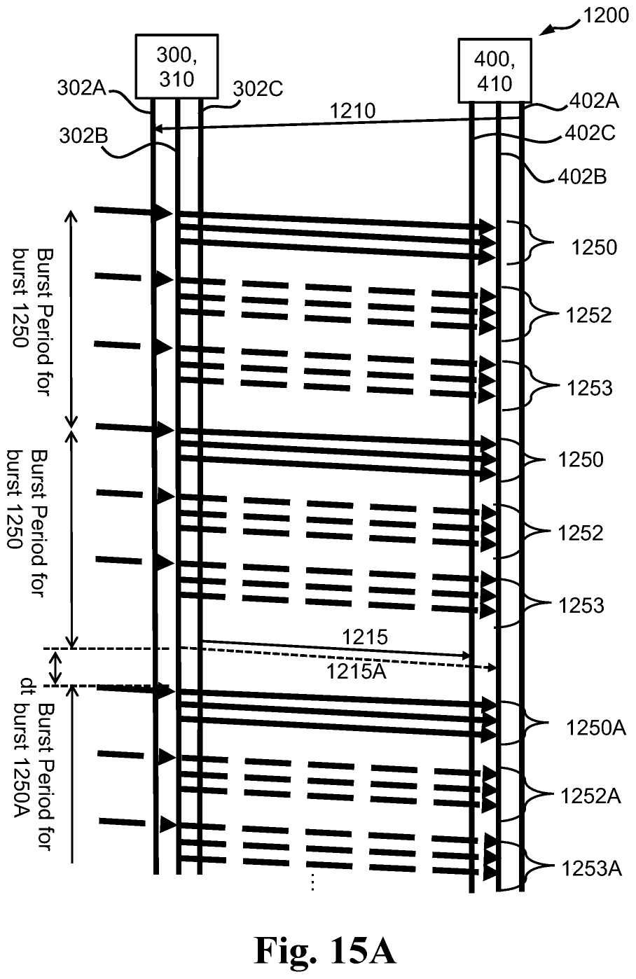

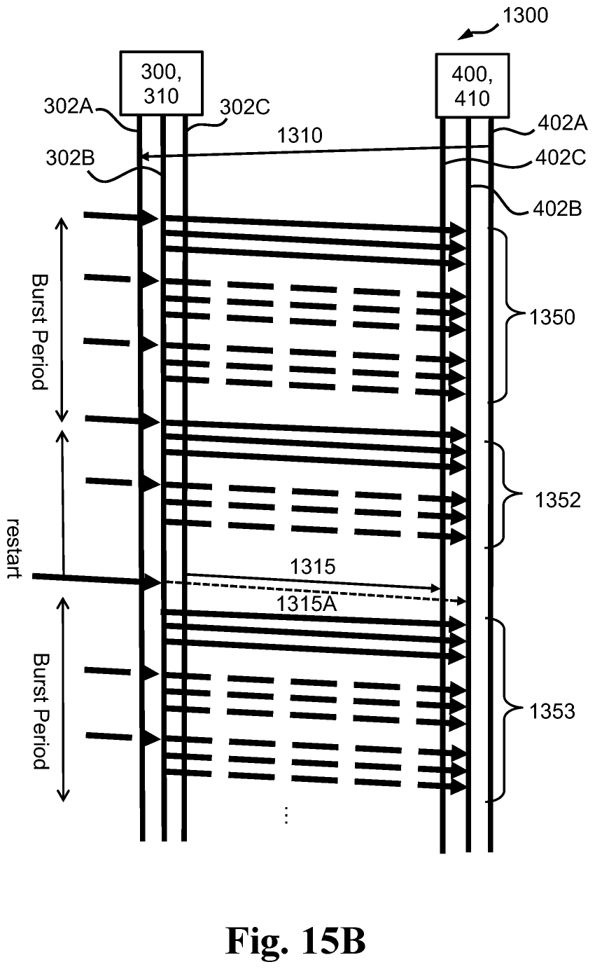

The method 500 comprises transmitting S502, to the network node, control information indicative of a time adjustment parameter for adjusting a timing of an allocation of a configured resource at the network node. The control information indicative of the time adjustment parameter may be configured by RRC or implicitly configured. The time adjustment parameter may be seen as an offset, such as a nudge timer. This is illustrated in FIGS. 14 and 15A-B.

The method 500 may comprise receiving, from the network node, control signalling indicative of an adjusted timing of the allocation of the configured resource.

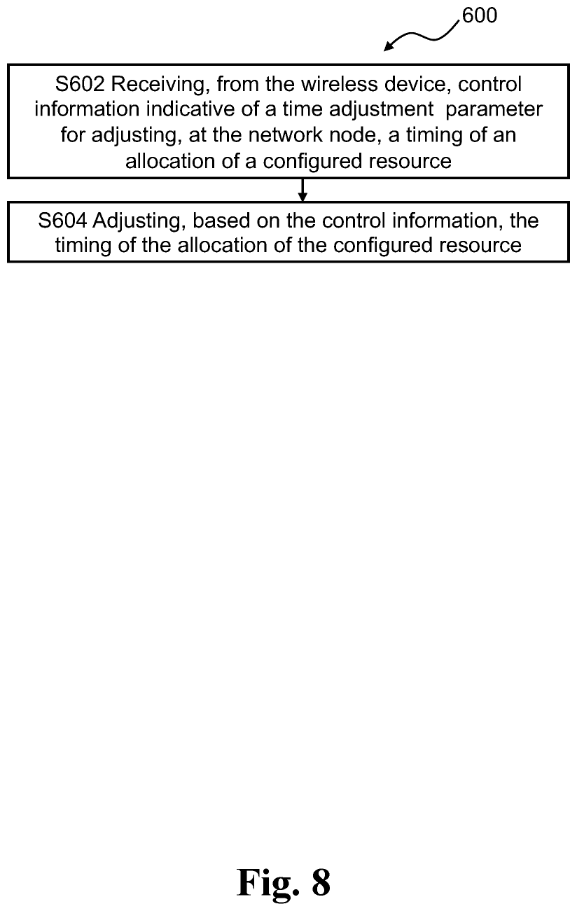

FIG. 8 shows a flow diagram of an example method 600, performed by a network node (such as network node 410 disclosed herein) according to the disclosure, for resource allocation of a data burst in uplink transmission from a wireless device. In one or more example methods, the data burst comprises one or more data packets. For example, the data burst comprises a plurality of data packets, for example associated with a same group.

The method 600 comprises receiving S602, from the wireless device, control information indicative of a time adjustment parameter for adjusting, at the network node, a timing of an allocation of a configured resource. In one or more example methods, the configured resource is for the uplink transmission of the data burst.

The method 600 comprises adjusting S604, based on the control information, the timing of the allocation of the configured resource.

The method 600 may comprise transmitting, to the wireless device, control signalling indicative of an adjusted timing of the allocation of the configured resource.

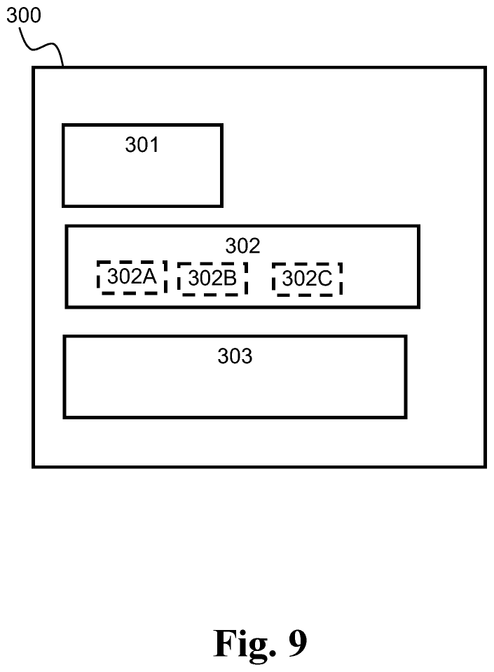

FIG. 9 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 5. In other words, the wireless device 300 may be configured for uplink transmission of a data burst to a network node.

The wireless device 300 is configured to transmit (such as via the wireless interface 303), to the network node, information indicative of a burst type.

The wireless device 300 is configured to receive (such as via the wireless interface 303), from the network node, control signalling indicative of an allocation of a configured resource for uplink transmission.

The wireless interface 303 is configured for wireless communications via a wireless communication system, such as a 3GPP system, such as a 3GPP system supporting one or more of: New Radio, NR, Narrow-band IoT, NB-IOT, and Long Term Evolution—enhanced Machine Type Communication, LTE-M, millimetre-wave communications, such as millimetre-wave communications in licensed bands, such as device-to-device millimetre-wave communications in licensed bands.

The processor circuitry 302 may operate according to one or more layers, such as layers of an Open Systems Interconnection, OSI, model, such as Radio Resource Control, RRC, layer 302A, medium access control, MAC, layer 302B, and physical layer 302C. The physical layer 302C may be referred to as L1 layer 302C, such as L1 layer 302C of the wireless device 300.

The wireless device 300 is optionally configured to perform any of the operations disclosed in FIG. 5 (such as any one or more of S102, S103, S104, S106). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 9). Memory circuitry 301 is considered a non-transitory computer readable medium.

Memory circuitry 301 may be configured to store information (such as information indicative of burst type) in a part of the memory.

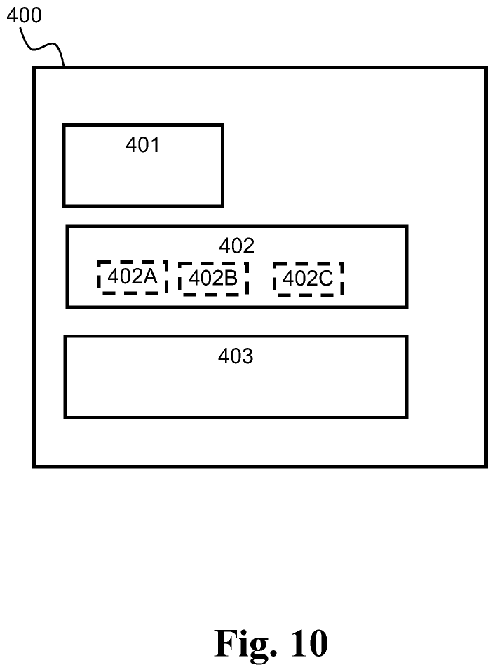

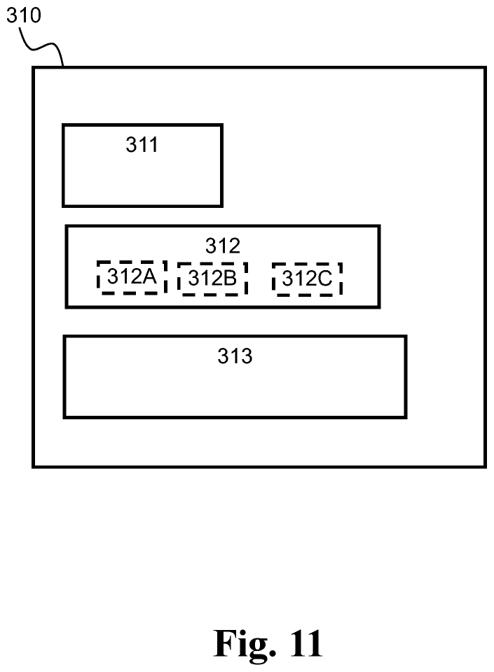

FIG. 10 shows a block diagram of an example network node 400 according to the disclosure. The network node 400 comprises memory circuitry 401, processor circuitry 402, and a wireless interface 403. The network node 400 may be configured to perform any of the methods disclosed in FIG. 6. In other words, the network node 400 may be configured for resource allocation of a data burst in uplink transmission from a wireless device.

The network node 400 is configured to receive (such as via the wireless interface 403), from the wireless device, information indicative of a burst type.

The network node 400 is configured to transmit (such as via the wireless interface 403), to the wireless device, based on the information, control signalling indicative of an allocation of a configured resource for uplink transmission of a data burst.

The wireless interface 403 is configured for wireless communications via a wireless communication system, such as a 3GPP system, such as a 3GPP system supporting one or more of: New Radio, NR, Narrow-band IoT, NB-IOT, and Long Term Evolution—enhanced Machine Type Communication, LTE-M, millimetre-wave communications, such as millimetre-wave communications in licensed bands, such as device-to-device millimetre-wave communications in licensed bands.

The processor circuitry 402 may operate according to one or more layers, such as layers of an OSI model, such as Radio Resource Control, RRC, layer 402A, medium access control, MAC, layer 402B, and physical layer 402C. The physical layer 402C may be referred to as L1 layer 402C, such as L1 layer 402C of the network node 400.

Processor circuitry 402 is optionally configured to perform any of the operations disclosed in FIG. 6 (such as any one or more of S202, S204, S205, S206, S208). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 10). Memory circuitry 401 is considered a non-transitory computer readable medium.

Memory circuitry 401 may be configured to store time information, information indicative of burst type, information regarding grant types, preconfigured grants, in a part of the memory.

FIG. 11 shows a block diagram of an example wireless device 310 according to the disclosure. The wireless device 310 comprises memory circuitry 311, processor circuitry 312, and a wireless interface 313. The wireless device 310 may be configured to perform any of the methods disclosed in FIG. 7. In other words, the wireless device 310 may be configured for uplink transmission of a data burst to a network node (such as network node 400, 410 of FIGS. 1, 10, 12 and 13 A-E and 15 A-B).

The wireless device 310 is configured to transmit (such as via the wireless interface 313), to the network node, control information indicative of a time adjustment parameter for adjusting a timing of an allocation of a configured resource at the network node for uplink transmission of a data burst.

The wireless interface 313 is configured for wireless communications via a wireless communication system, such as a 3GPP system, such as a 3GPP system supporting one or more of: New Radio, NR, Narrow-band IoT, NB-IOT, and Long Term Evolution—enhanced Machine Type Communication, LTE-M, millimetre-wave communications, such as millimetre-wave communications in licensed bands, such as device-to-device millimetre-wave communications in licensed bands.

The processor circuitry 312 may operate according to one or more layers, such as layers of an Open Systems Interconnection, OSI, model, such as Radio Resource Control, RRC, layer 312A, medium access control, MAC, layer 312B, and physical layer 312C.

The wireless device 310 is optionally configured to perform any of the operations disclosed in FIG. 7 (such as S502). The operations of the wireless device 310 may be embodied in the form of executable logic routines (for example, lines of code, software programs, etc.) that are stored on a non-transitory computer readable medium (for example, memory circuitry 311) and are executed by processor circuitry 312).

Furthermore, the operations of the wireless device 310 may be considered a method that the wireless device 310 is configured to carry out. Also, while the described functions and operations may be implemented in software, such functionality may also be carried out via dedicated hardware or firmware, or some combination of hardware, firmware and/or software.

Memory circuitry 311 may be one or more of a buffer, a flash memory, a hard drive, a removable media, a volatile memory, a non-volatile memory, a random access memory (RAM), or other suitable device. In a typical arrangement, memory circuitry 311 may include a non-volatile memory for long term data storage and a volatile memory that functions as system memory for processor circuitry 312. Memory circuitry 311 may exchange data with processor circuitry 312 over a data bus. Control lines and an address bus between memory circuitry 311 and processor circuitry 312 also may be present (not shown in FIG. 11). Memory circuitry 311 is considered a non-transitory computer readable medium.

Memory circuitry 311 may be configured to store control information in a part of the memory.

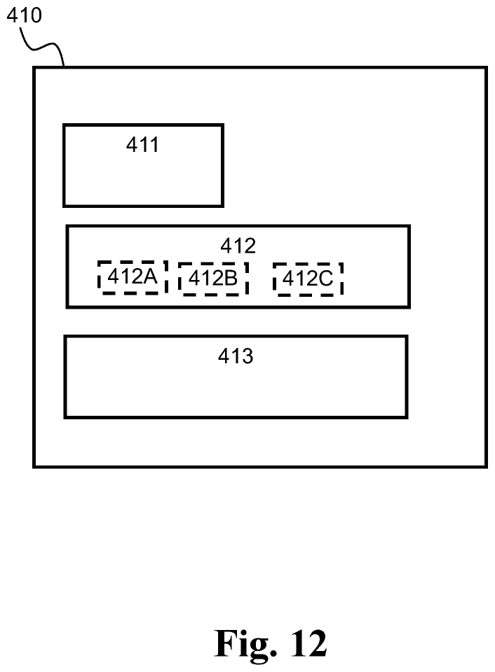

FIG. 12 shows a block diagram of an example network node 410 according to the disclosure. The network node 410 comprises memory circuitry 411, processor circuitry 412, and a wireless interface 413. The network node 410 may be configured to perform any of the methods disclosed in FIG. 8. In other words, the network node 410 may be configured for resource allocation of a data burst in uplink transmission from a wireless device (such as wireless device 300, 310 of FIGS. 1, 9, 11 and 13 A-E and 15 A-B).

The network node 410 is configured to receive (such as via the wireless interface 403), from the wireless device, control information indicative of a time adjustment parameter for adjusting, at the network node, a timing of an allocation of a configured resource. In one or more example network nodes, the configured resource is for the uplink transmission of the data burst.

The network node 410 is configured to adjust (such as using the processor circuitry 412), based on the control information, the timing of the allocation of the configured resource for uplink transmission of the data burst.

The wireless interface 413 is configured for wireless communications via a wireless communication system, such as a 3GPP system, such as a 3GPP system supporting one or more of: New Radio, NR, Narrow-band IoT, NB-IOT, and Long Term Evolution—enhanced Machine Type Communication, LTE-M, millimetre-wave communications, such as millimetre-wave communications in licensed bands, such as device-to-device millimetre-wave communications in licensed bands.

The processor circuitry 412 may operate according to one or more layers, such as layers of an OSI model, such as Radio Resource Control, RRC, layer 412A, medium access control, MAC, layer 412B, and physical layer 412C.

Processor circuitry 412 is optionally configured to perform any of the operations disclosed in FIG. 8 (such as any one or more of S602, S604). The operations of the network node 410 may be embodied in the form of executable logic routines (for example, lines of code, software programs, etc.) that are stored on a non-transitory computer readable medium (for example, memory circuitry 411) and are executed by processor circuitry 412).

Furthermore, the operations of the network node 410 may be considered a method that the network node 410 is configured to carry out. Also, while the described functions and operations may be implemented in software, such functionality may also be carried out via dedicated hardware or firmware, or some combination of hardware, firmware and/or software.

Memory circuitry 411 may be one or more of a buffer, a flash memory, a hard drive, a removable media, a volatile memory, a non-volatile memory, a random access memory (RAM), or other suitable device. In a typical arrangement, memory circuitry 411 may include a non-volatile memory for long term data storage and a volatile memory that functions as system memory for processor circuitry 412. Memory circuitry 411 may exchange data with processor circuitry 412 over a data bus. Control lines and an address bus between memory circuitry 411 and processor circuitry 412 also may be present (not shown in FIG. 12). Memory circuitry 411 is considered a non-transitory computer readable medium.

Memory circuitry 411 may be configured to store information indicative of burst type in a part of the memory.

FIGS. 13A-E are signalling diagrams illustrating example communications between an example wireless device 300 and an example network node 400 according to this disclosure.

In FIGS. 13A-E, the wireless device 300 can include layers (such as layers of the Open Systems Interconnection, OSI model), three of which are shown in FIG. 7. The layers include the Radio Resource Control (RRC) layer 302A, the medium access control (MAC) layer 302B, and the physical layer (L1) 302C. Other layers can be utilized as well, and the disclosure is not so limited.

In FIGS. 13A-E, the network node 400 can include layers (such as layers of the Open Systems Interconnection, OSI model), three of which are shown in FIG. 7. The layers include the Radio Resource Control (RRC) layer 402A, the medium access control (MAC) layer 402B, and the physical layer (L1) 402C. Other layers can be utilized as well, and the disclosure is not so limited.

FIG. 13A shows an example non-limiting implementation 700 of the disclosed technique.

The network node 400 can configure, using RRC layer, a configured signalling-radio network temporary identifier (CS-RNTI) for the wireless device 300, by transmitting a first signal 710. The first signal 710 may include, for example, data indicative of a configuration of a configured signalling-radio network temporary identifier (CS-RNTI). The first signal 710 may be transmitted from the RRC layer 402A of the network node 400 to the RRC layer 302A of the wireless device 300.

In one or more examples, the wireless device 300 may be configured to receive the first signal 710, such as in a signalling plane, from the network node 400. Thus, the network node 400 may be configured to transmit the first signal 710 to the wireless device 300.

The wireless device 300 may hold information regarding an upcoming data burst, such as from upper layers and may determine a burst type corresponding to the upcoming data burst. For example, the wireless device may predict an upcoming data burst, such as data bursts illustrated in FIG. 3A.

In one or more examples, the wireless device 300 can be configured to transmit, to the network node 400, information 712 indicative of a burst type, such as the burst type of the upcoming data burst at the wireless device. This information may be contained in a second signal, such as using a signalling plane. Thus, the network node 400 may be configured to receive the information 712 from the wireless device 300. The information 712 may be seen as a request pattern activation. The information 712 may be transmitted from the MAC sublayer 302B of the wireless device 300 to the MAC sublayer 402B of the network node 400.

The information 712 is indicative of a burst type. For example, the information 712 may be indicative of one or more of: a periodicity of a data burst and size information of the data burst (such as a burst size of a data burst (k)). The information 712 can be indicative of one or more of: an expected periodicity and an expected burst size of the data burst. The information 712 can be predictive of one or more of: a periodicity and a burst size of the data burst. The information 712 can be associated or can point to a predefined table index. There may be envisaged to have a predefined table associating a burst type to corresponding parameters such as periodicity and size, via an index. For example, the information 712 indicative of the burst type may indicate the index. In one or more example, the information 712 indicative of the burst type may indicate the parameters, such as periodicity and/or size. In one or more examples, the information 712 indicative of the burst type may comprise the parameters, such as periodicity and/or size. The information 712 can be indicative of further properties of the data burst.

In one or more examples, the wireless device 300 may be configured to receive, from the network node 400, control signalling 714 indicative of an allocation of a configured resource for uplink transmission. The control signalling may be in form of one or more control messages. The control signalling may be in form of a flag activating a preconfigured grant. The control signalling can give the wireless device a permission to transmit the data burst(s) according to a configured grant pattern, such as at occasions according to the configured grant pattern. A configured grant pattern may be seen as a grant pattern configured to serve and/or match well the data burst pattern. The control signalling may be in a third signal, such as in a signalling plane. The control signalling 714 may be configured to activate a pattern, optionally with a Downlink Control Information, DCI, scrambled with CS-RNTI to the wireless device 300. Thus, the network node 400 can be configured to transmit the control signalling 714 to the wireless device 300. The control signalling 714 can include a grant, such as a configured grant and/or a pre-configured grant. The grant may be a configured grant determined based on the information 712. The grant can be indicative of a resource allocation for a configured resource. The grant can be indicative of a pattern, such as period or periodicity associated with the pattern. The grant can be indicative of a pattern in the data burst and/or of a shape of the data burst, such as a data burst structure and/or pattern. For example, the grant can include an indication on uplink time slots to be used with the grant. The control signalling 714 may be transmitted from the L1 layer 402C of the network node 400 to the L1 layer 302C of the wireless device 300. The control signalling 714 can be based on one or more of: 710 and 712. For example, the information in 710 may be used to scramble part of the control signalling 714.

In one or more examples, the wireless device 300 can be configured to obtain from upper layer a data burst 716 comprising data packets 718. The data burst may have a size n. For example the data burst is transmitted in a user plane. For example, the wireless device 300 can be configured to obtain the data burst 716 at the MAC layer 302B.

In one or more examples, the wireless device 300 can be configured to transmit data packets 718, 722, 723, 724 of data burst 716, such as in Transport Blocks having a corresponding Transport Block Size, TBS, to the network node 400. Thus, the network node 400 can be configured to receive the data packets 718, 722, 723, 724 from the wireless device 300. For example, the wireless device 300 can be configured to transmit data packets 718, 722, 723, 724 according to the grant indicated in 714. The wireless device 300 can be configured to transmit the data packets 718, 722, 723, 724 from the MAC sublayer 302B to the MAC sublayer 402B of the network node 400.

In one or more examples, the wireless device 300 can be configured to transmit an indicator 720 indicative of a property of the data packets for uplink transmission. The indicator 720 may be a MAC control element (MAC-CE) transmitted in a signalling plane, to the network node 400. Thus, the network node 400 can be configured to receive the indicator 720 from the wireless device 300. The wireless device 300 can be configured to transmit the indicator from the MAC sublayer 302B to the MAC sublayer 402B of the network node 400.

The indicator 720 indicative of a property of the data burst for uplink transmission may be indicative of the type of the data burst 716, and/or an actual size of the data burst 716 obtained by the wireless device 300. For example, the indicator can include the actual size of the data burst 716. The indicator 720 can include further information on the data burst as well. In one or more examples, the network node 400 may be configured to transmit an updated grant to the wireless device 300 based on the received indicator 720. The updated grant may advantageously more closely confirm to the size and the timing of the data burst 716. The updated grant may be smaller and/or larger than the original grant. This may free up resource allocations for other wireless devices in the network.

The wireless device 300 can be configured to continue to transmit the last data packet 724 or last transport block (such as TBS) based on the static grant from 714. Padding data may be used in some situation in 724.

In one or more examples, the wireless device 300 can be configured to obtain from upper layer an indication of a data burst 725 of size m, for example after a period following a pattern period. The data burst may comprise data packets 726, 730, 732. An indicator 728 indicative of a property of the data burst 725 for uplink transmission may be sent from the wireless device 300 to the network node 400. The indicator 728 serves the same purpose for data burst 725 as indicator 720 for data burst 716.

FIG. 13B shows an example non-limiting implementation 800 of the disclosed technique with a wireless device 300 and a network node 400. The wireless device 300 and the network node 400 can include the same layers as discussed above with respect to FIG. 13A.

The network node 400 can configure, using RRC layer, a configured signalling-radio network temporary identifier (CS-RNTI) for the wireless device 300, by transmitting a first signal 810. The first signal 810 may include, for example, data indicative of a configuration of a configured signalling-radio network temporary identifier (CS-RNTI). The first signal 810 may be transmitted from the RRC layer 402A of the network node 400 to the RRC layer 302A of the wireless device 300.

In one or more examples, the wireless device 300 may be configured to receive the first signal 810, such as in a signalling plane, from the network node 400. Thus, the network node 400 may be configured to transmit the first signal 810 to the wireless device 300.

The wireless device 300 may hold information regarding an upcoming data burst, such as from upper layers and may determine a burst type corresponding to the upcoming data burst.

In one or more examples, the wireless device 300 can be configured to transmit, to the network node 400, information 812 indicative of a burst type, such as the burst type of the upcoming data burst at the wireless device. This information may be contained in a second signal, such as using a signalling plane. Thus, the network node 400 may be configured to receive the information 812 from the wireless device 300. The information 812 may be seen as a request pattern activation. The information 812 may be transmitted from the MAC sublayer 302B of the wireless device 300 to the MAC sublayer 402B of the network node 400.

The information 812 is indicative of a burst type. For example, the information 812 may be indicative of one or more of: a periodicity of a data burst and size information of the data burst (such as a burst size of a data burst (k)). The information 812 can be indicative of one or more of: an expected periodicity and an expected burst size of the data burst. The information 812 can be predictive of one or more of: a periodicity and a burst size of the data burst. The information 812 can be associated or can point to a predefined table index. There may be envisaged to have a predefined table associating a burst type to corresponding parameters such as periodicity and size, via an index. For example, the information 812 indicative of the burst type may indicate the index. In one or more example, the information 812 indicative of the burst type may indicate the parameters, such as periodicity and/or size. In one or more examples, the information 812 indicative of the burst type may comprise the parameters, such as periodicity and/or size. The information 812 can be indicative of further properties of the data burst.

In one or more examples, the wireless device 300 may be configured to receive, from the network node 400, control signalling 814 indicative of an allocation of a configured resource for uplink transmission. The control signalling may be in form of one or more control messages and/or of a flag giving the wireless device a permission to transmit the data bursts according to a configured grant pattern, such as at occasions according to the configured grant pattern. A configured grant pattern may be seen as a grant pattern configured to serve and/or match well the data burst pattern. The control signalling may be in a third signal, such as in a signalling plane. The control signalling 814 can be configured to activate a pattern, optionally with a DCI scrambled with CS-RNTI to the wireless device 300. Thus, the network node 400 can be configured to transmit 814 to the wireless device 300. The control signalling 814 can include a grant, such as a configured grant. The grant may be a static grant. The grant can include an indication on uplink slots to be used with the grant. The control signalling 814 may be transmitted from the L1 layer 402C of the network node 400 to the L1 layer 302C of the wireless device 300. The control signalling 814 can be based on one or more of: 810 and 812.

The control signalling 814 can include a grant referring only to the first data packet in each data bursts 816, 825. For example, the control signalling 814 can include a grant of the first TBS in each data burst only.

The wireless device 300 can receive the data burst 816 of size n and transmit the data packets 818, 822, 823, 824 to the network node 400 as discussed above with respect to data packets 718, 722, 723, 724 of FIG. 13A. Further, the wireless device 300 can transmit an indicator 820 which may be similar to 720 of FIG. 13A.

The first data packet 818, such as first TBS is sent with the grant obtained from 814.

In one or more examples, the network node 400 can revert to dynamic scheduling for link adaptation and accurate resource allocation based on the actual received size of the data burst 816 (such as load). The network node 400 can be configured to transmit a dynamic grant 821 to the wireless device 300. The wireless device 300 can be configured to receive a dynamic grant 821 from the network node 400. The dynamic grant 821 can be based on the actual burst size received in the indicator 820.

In one or more examples, the dynamic grant 821 can be sent by the network node 400 to the wireless device 300 after receiving the indicator 820. In one or more examples, the dynamic grant 821 can be sent by the network node 400 prior to receiving the indicator 820 and may be based on the size n.

The wireless device 300 can be configured to continue to transmit data packet 822 to the network node 400. The wireless device 300 can be configured to continue to transmit data packet 822 to the network node 400 based on the dynamic grant 821, for example until all of the data packets of the data burst 816 have been sent. For example, the dynamic grant 821 is updated after every data packet transmissions, such as packet 823, as illustrated by 821A and 821B. In other words, for example, every new uplink, UL, transmission requires a new uplink, UL, grant. For example, the dynamic grant 821 is updated after a particular burst period. This allows dynamically adapting the grant to the radio conditions, network load, and timing (indicating which uplink, UL, slots to use).

After the burst period ends, the wireless device 300 can receive a new data burst 825 of size m. The new data burst 825 may be the same size or a different size than that of data burst 816. The wireless device 300 and network node can then be configured to repeat the process discussed above with respect to the new data burst 825 with data packets 826, 829, 831 and corresponding indicator 827, and optionally corresponding dynamic grant 828, 830.

FIG. 13C shows an example non-limiting implementation 900 of the disclosed technique with a wireless device 300 and a network node 400. The wireless device 300 and the network node 400 can include the same layers as discussed above with respect to FIGS. 13A-B.

The network node 400 can configure, using RRC layer, a configured signalling-radio network temporary identifier (CS-RNTI) for the wireless device 300, by transmitting a first signal 910, similar to FIGS. 13A-B.

Similar to FIGS. 13A-B, the network node 400 and the wireless device can exchange information 912 indicative of a burst type and control signalling 914 indicative of an allocation of a configured resource.

The wireless device 300 can receive a data burst and transmit the data packets 918 and consecutive data packets illustrated in thick solid lines to the network node 400 in a similar manner as in FIGS. 13A-B. Further, the wireless device 300 can transmit indicator 920 indicative of a property of the data burst such as burst size and/or type of data packets as discussed with respect to indicator 720 and 820 of FIG. 13A-B. As shown, the wireless device 300 may transmit the data burst, for example following a pattern period (illustrated by Pattern Period 1 and Pattern Period 2 in FIG. 13C) and the indicator 920 to the network node 400 one or more times.

In FIG. 13C, the first two data bursts with respective data packets 918 and 919 have the same general configuration, and thus can have the same pattern, such as for allocation of configured resources. However, a third data burst with data packet 921 can be of a different pattern than the first two data bursts with respective data packets 918 and 919. In one or more example methods, the wireless device 300 can be configured to send an update indicator 920A (such as updating MAC-CE). The update indicator 920A can be configured to update the pattern configuration from pattern period 1 to pattern period 2 illustrated in FIG. 13C. This may occur as the third data burst can have a different size and/or period, for example, as compared to the first two data bursts. As one example, the third data burst may have a new frame rate as compared to the first data bursts, which would utilize a different resource allocation. By being able to adaptively update the pattern, more efficient resource allocation can be performed.

FIG. 13D shows an example non-limiting implementation 1000 of the disclosed technique with a wireless device 300 and a network node 400. The wireless device 300 and the network node 400 can include the same layers as discussed above with respect to FIGS. 13A-C.

The network node 400 can configure, using RRC layer, a configured signalling-radio network temporary identifier (CS-RNTI) for the wireless device 300, by transmitting a first signal 1010, similar to FIGS. 13A-C.

Similar to FIGS. 13A-C, the network node 400 and the wireless device can exchange information 1012 indicative of a burst type and control signalling 1014 indicative of an allocation of a configured resource.

FIG. 13D illustrates an application of the disclosed technique to a pattern having two different burst types. This may be applicable to a pattern having more than two different burst types. The pattern comprises data burst 1050 followed by 2 data bursts 1052 until expiry of the pattern period. At expiry of the pattern period, the data burst 1050 followed by 2 data bursts 1052 may be transmitted.

The wireless device 300 can receive data burst 1050 and transmit the data packets and consecutive packets forming the data burst 1050 to the network node 400 in a similar manner as in FIGS. 13A-C. Further, the wireless device 300 can transmit indicator 1020 indicative of a property of the data burst such as size and/or type of data burst as discussed with respect to indicator 720 and 820 and 920 of FIG. 13A-C.

In one or more example methods, the data obtained by the wireless device from its upper layers may correspond to multiple burst types, such as first burst type for data burst 1050 and second burst type for data burst 1052. The burst type may be related to I frames and P/B frames. The first burst type and the second burst type may have different periodicity and/or size, or may have the same periodicity and/or size. Periodicity and burst size can still be used for resource allocation, but it also may be advantageous to also include the relative priority of the different burst types.

The example 1000 shown in FIG. 13D can include the signalling and data bursts discussed with respect to FIGS. 13A-C. The information 1012 may include any or all of the features of 712, 812, and/or 912, and may also be indicative of priority information, such as relative priority between burst types. The control signalling 1014 can be based on 1012, and may be configured to allocate resources based on the priority of burst type between first burst type of 1050 and second burst type of 1052. FIG. 13D illustrates a pattern period for example for the first burst type of 1050 and for the second burst type of 1052.

FIG. 13E shows an example non-limiting implementation 1100 of the disclosed technique with a wireless device 300 and a network node 400. The wireless device 300 and the network node 400 can include the same layers as discussed above with respect to FIGS. 13A-D.

The network node 400 can configure, using RRC layer, a configured signalling-radio network temporary identifier (CS-RNTI) for the wireless device 300, by transmitting a first signal 1110, similar to FIGS. 13A-D.

Similar to FIGS. 13A-D, the wireless device 300 transmit information 1112 indicative of a burst type. The information 1112 may include any or all of the features of information 712 of FIG. 13A, and may also include data indicative of burst type. The information 1112 may include burst size and information regarding relative priority. The information 1112 may not be indicative of periodicity, which can provide more freedoms.

The wireless device 300 may obtain a data burst 1150 from upper layers, where the data burst is of the first type, illustrated as Burst type 1 in FIG. 13E. In one or more example methods, the data received by the wireless device 300 may include multiple burst types, such as first burst type (such as first type for data burst 1150 and second type for data burst 1152). The first burst type and the second burst type may have different periodicity and/or size, or may have the same periodicity and/or size. Periodicity and burst size can still be used for resource allocation, but it also may be advantageous to include the relative priority and/or the burst type of the different burst types.

The wireless device 300 can be configured to transmit, to the network node 400, a first request 1113, via the physical layer 302C, for resources to send a data burst 1150 of the first burst type. The network node 400 can be configured to receive, at physical layer 402C, a request 1113, from the wireless device 300. This may be done at the MAC layer 302B and 402B as illustrated by request 1113A (such as using MAC-CE).

The wireless device can receive control signalling 1114 indicative of an allocation of a configured resource, such as including a permission to use a configured grant to transmit the data burst 1150 of the first burst type.

The example 1100 shown in FIG. 13E can include the signalling and data bursts discussed with respect to FIGS. 13A-D.

The wireless device 300 can be configured to transmit data packets of the data burst 1150 of the first burst type to the network node 400.

Once the wireless device has finished transmitting the data packets of the data burst 1150 of the first burst type, the wireless device 300 may obtain, for example from upper layer, a data burst 1152 of a second burst type (illustrated as burst type 2 in FIG. 13E). The wireless device 300 can be configured to transmit, to the network node 400, a second request 1123 or 1123A for resources for data burst 1152 of the second burst type. The second request 1123 may comprise information indicative of the burst type.

The network node 400 can transmit control signalling 1124, including a grant to transmit the data burst 1152 of the second burst type. The wireless device 300 can be configured to transmit data packets of the data burst 1152 of the second burst type to the network node 400.

Advantageously, the example of FIG. 13E can allow for freedom to change between burst types as needed by the wireless device 300.

FIG. 14 shows is a schematic diagram illustrating example configured grant patterns with time adjustment according to this disclosure. The example configured grant patterns show configured grants for data bursts (illustrated in solid black boxes and in solid white boxes in FIG. 14) and illustrate utilizing control information indicative of a time adjustment parameter, for example for resetting a pattern according to the disclosure.

The top chart of FIG. 14 shows an initial configured grant pattern before any time adjustment. The bottom chart of FIG. 14 shows a configured grant pattern that has been adjusted using the disclosed time adjustment parameter to compensate for a drift in time, such as a clock drift. The drift may be detected by the wireless device. There may be a need to reset the particular allocation pattern, due to any number of reasons. For example, the frames per second may be changed, or signals may weaken or improve. The time adjustment parameter disclosed herein may be used to reset an allocation pattern, such as a configured grant pattern.

As shown in the bottom chart of FIG. 14, the pattern can be reset at time to by a particular timing dt. The pattern can be reset, such as re-synchronized, via the control information indicative of a time adjustment parameter disclosed herein, in order to utilize an appropriate resource allocation.

FIGS. 15A-B show signalling diagrams illustrating example communications between an example wireless device and an example network node according to this disclosure.

FIG. 15A shows an example non-limiting implementation 1200 of the disclosed technique with a wireless device 300, 310 and a network node 400, 410. The wireless device 300, 310 and the network node 400, 410 can include the same layers as discussed above with respect to FIGS. 13A-E.

The communications discussed in relation to FIGS. 15A-B for wireless device 300 are applicable to wireless device 310. The communications discussed in relation to FIG. 15A for network 400 are applicable to network node 410.

In one or more example methods, the RRC layer 402A of the network node 400 can be configured to provide, such as configure, data 1210 indicative of a time adjustment parameter (such as a nudge timer) for adjusting a timing of an allocation of a configured resource at the network node. This may be explicitly or implicitly signalled. The network node 400 can be configured to provide data 1210 to the RRC layer 302A of the wireless device 300 in a set up phase. Accordingly, the wireless device 300 can be configured to receive the data 1210 from the network node 400.

The wireless device 300 can be configured to transmit one or more data bursts 1250, 1252, 1253 to the network node 400. As shown in FIG. 15A, the data burst 1250 can follow a periodicity with a burst period for repeating the transmission of the data burst illustrated in thick solid lines. These are merely illustrative, and other patterns can be used as well. The same can apply to data burst 1252, 1253.

The wireless device 300 can be configured to repeat the transmission of data bursts as time progresses. However, the data burst transmission may become out of synchronization with the resource allocation, thereby leading to poor data transmission.

In one or more example methods, the wireless device 300 can be configured to transmit control information 1215, 1215A indicative of a time adjustment parameter to the network node 400.

The control information 1215, 1215A can be, for example, a request and/or a flag to adjust the grant timing by the network node by a drift amount dt. The drift amount may be the same as the amount of drift observed to deviate from the burst period. The network node 400 may be configured to adjust the grant timing by the drift amount according to the control information 1215, 1215A. This can allow for the data bursts 1250A, 1252A, 1253A to be re-synchronized, thereby avoiding resource allocation where the wireless device 300 does not have the data yet, and avoiding increased latency.

The control information indicative of the time adjustment parameter may be transmitted via physical layer as illustrated by 1215, and/or via MAC layer as illustrated by 1215A.

FIG. 15B shows an example non-limiting implementation 1300 of the disclosed technique with a wireless device 300 and a network node 400. The wireless device 300 and the network node 400 can include the same layers as discussed above with respect to FIGS. 13A-E.

In one or more example methods, the RRC layer 402A of the network node 400 can be configured to provide, such as configure, data 1310 indicative of a time adjustment parameter (such as a nudge timer) for adjusting a timing of an allocation of a configured resource at the network node. This may be explicitly or implicitly performed. The network node 400 can be configured to provide the data 1310 to the RRC layer 302A of the wireless device 300

The wireless device 300 can be configured to transmit one or more data bursts 1350, 1352, 1353 to the network node 400. As shown in FIG. 15B, the data burst 1350 can follow a burst period for repeating the transmission with data burst, such as 1352 repeated after 1350. These is merely illustrative, and other burst data patterns can be used as well. The same can apply to data burst 1353.

The wireless device 300 can be configured to repeat the transmission of data burst 1352 as time progresses. However, the data burst transmissions may, for one reason or another, need to have the pattern reset. For example, the frames per second of data burst 1352 may be changed, requiring a restart, or reset, of the data pattern already provided by the network node 400. For example, the media encoder triggers a pattern restart.

In one or more example methods, the wireless device 300 can be configured to transmit control information 1315, 1315A indicative of a time adjustment parameter to the network node 400, for resetting the configured grant pattern.

The control information 1315, 1315A indicative of the time adjustment parameter can be, for example, a request to trigger a pattern restart. This may be determined by a media encoder of the wireless device. The network node 400 may be configured to restart the configured grant pattern for data burst 1353. This can allow for the pattern of the grant from the network node 400 to be reset, thereby avoiding resource allocation where the wireless device 300 has a change in burst pattern, and avoiding increased latency.

The control information indicative of the time adjustment parameter may be transmitted via physical layer as illustrated by 1315, and/or via MAC layer as illustrated by 1315A.

The time adjustment parameter can be used for “nudging” or “resetting” as discussed above, or can be used in combination. A wireless device 300 can be configured to provide a time adjustment parameter that can be used to nudge or reset a configured grant pattern from a network node 400. A network node 400 can be configured to receive a time adjustment parameter that can be used to nudge or reset a grant pattern from a wireless device.

The wireless device 300 may be configured to send a time adjustment parameter for nudging the pattern and/or a time adjustment parameter for resetting the pattern.

Examples of methods and products (100, 200, 500, 600, 300,310, 400, 410) according to the disclosure are set out in the following items:
1. A method, performed by a wireless device, for uplink transmission of a data burst to a network node, the method comprising:
   transmitting (S102), to the network node, information indicative of a burst type; and
   receiving (S104), from the network node, control signalling indicative of an allocation of a configured resource for uplink transmission.
2. The method according to item 1, wherein the information indicative of the burst type comprises information indicative of a pattern in the data bursts and/or of a shape of the data bursts.
3. The method according to any of the previous items, the method comprising updating (S103), based on a change in traffic conditions and/or in radio conditions, the information indicative of the burst type.
4. The method according to any of the previous items, wherein the information indicative of the burst type comprises time information related to the data burst.
5. The method according to item 4, wherein the time information is indicative of a periodicity of the data burst and/or of an order of the data burst.
6. The method according to any of items 4-5, wherein the time information is indicative of a time adjustment parameter for adjusting a timing of the allocation of the configured resource at the network node.
7. The method according to any of the previous items, wherein the information indicative of the burst type comprises size information of the data burst.
8. The method according to item 7, wherein the size information of the data burst comprises a statistical parameter indicative of a size of the data burst and/or a change in the size of the data burst.
9. The method according to any of the previous items, wherein the information indicative of the burst type comprises priority information between burst types and/or data packets.
10. The method according to any of the previous items, the method comprising transmitting (S106), to the network node, an indicator indicative of a property of the data burst for uplink transmission.
11. The method according to any of the previous items, wherein control signalling indicative of the allocation of the configured resource for uplink transmission is based on the burst type.
12. The method according to any of the previous items, wherein the control signalling indicative of the allocation of the configured resource for uplink transmission comprises control signalling indicative of a configured grant.
13. The method according to any of the previous items, wherein the data burst comprises a plurality of data packets, wherein the plurality of data packets is associated with a same group.
14. A method, performed by a network node, for resource allocation of a data burst in uplink transmission from a wireless device, the method comprising:
   receiving (S202), from the wireless device, information indicative of a burst type; and
   transmitting (S205), to the wireless device, based on the information, control signalling indicative of an allocation of a configured resource for uplink transmission.
15. The method according to item 14, the method comprising pre-configuring (S204), based on the burst type, a grant and/or a grant type for the uplink transmission.
16. The method according to any of items 14-15, wherein control signalling indicative of the allocation of the configured resource for uplink transmission comprises control signalling indicative of a pre-configured grant.
17. The method according to any of items 14-16, wherein the information indicative of the burst type comprises information indicative of a pattern in data bursts and/or of a shape of the data bursts.
18. The method according to any of items 14-17, wherein the information indicative of the burst type comprises time information related to the data burst.
19. The method according to item 18, wherein the time information is indicative of a periodicity of the data burst and/or of an order the data burst.
20. The method according to any of items 18-19, wherein the time information is indicative of a time adjustment parameter for adjusting a timing of the allocation of the configured resource at the network node.
21. The method according to any of items 14-20, wherein the information indicative of the burst type comprises size information of the data burst.
22. The method according to any of items 14-21, wherein the information indicative of the burst type comprises priority information between burst types and/or data packets.
23. The method according to any of items 14-22, the method comprising receiving (S206), from the wireless device, an indicator indicative of a property of the data burst for uplink transmission.
24. The method according to any of items 14-23, the method comprising determining (S208), based on the indicator, the allocation of the configured resource.
25. The method according to any of items 14-24, wherein the data burst comprises a plurality of data packets, wherein the plurality of data packets is associated with a same group.
26. A method, performed by a wireless device, for uplink transmission of a data burst to a network node, wherein the data burst comprises a plurality of data packets, the method comprising:
1 transmitting (S502), to the network node, control information indicative of a time adjustment parameter for adjusting a timing of an allocation of a configured resource at the network node.
27. A method, performed by a network node, for resource allocation of a data burst in uplink transmission from a wireless device, wherein the data burst comprises a plurality of data packets, the method comprising:
   receiving (S602), from the wireless device, control information indicative of a time adjustment parameter for adjusting, at the network node, a timing of an allocation of a configured resource, wherein the configured resource is for the uplink transmission of the data burst; and
   adjusting (S604), based on the control information, the timing of the allocation of the configured resource.
28. A wireless device (300) comprising memory circuitry (301), processor circuitry (302), and a wireless interface (303), wherein the wireless device (300) is configured to:
   transmit, to a network node, information indicative of a burst type; and
   receive, from the network node, control signalling indicative of an allocation of a configured resource for uplink transmission of a data burst.
29. The wireless device according to item 28, wherein the information indicative of the burst type comprises information indicative of a pattern in data bursts and/or of a shape of the data bursts.
30. The wireless device according to any of items 28-29, wherein the processor circuitry is configured to update, based on a change in traffic conditions and/or in radio conditions, the information indicative of the burst type.
31. The wireless device according to any of items 28-30, wherein the information indicative of the burst type comprises time information related to the data burst.
32. The wireless device according to any of items 28-31, wherein the time information is indicative of a periodicity of the data burst and/or of an order of the data burst.
33. The wireless device according to any of items 28-32, wherein the time information is indicative of a time adjustment parameter for adjusting a timing of the allocation of the configured resource at the network node.
34. The wireless device according to any of items 28-33, wherein the information indicative of the burst type comprises size information of the data burst.
35. The wireless device according to any of items 28-34, wherein the size information of the data burst comprises a statistical parameter indicative of a size of the data burst and/or a change in the size of the data burst.
36. The wireless device according to any of items 28-35, wherein the information indicative of the burst type comprises priority information between burst types and/or data packets.
37. The wireless device according to any of items 28-36, wherein the wireless device (300) is configured to transmit, to the network node, an indicator indicative of a property of the data burst for uplink transmission.
38. The wireless device according to any of items 28-37, wherein control signalling indicative of the allocation of the configured resource for uplink transmission is based on the burst type.
39. The wireless device according to any of items 28-38, wherein the control signalling indicative of the allocation of the configured resource for uplink transmission comprises control signalling indicative of a configured grant.
40. The wireless device according to any of items 28-39, wherein the data burst comprises a plurality of data packets, wherein the plurality of data packets is associated with a same group.
41. A network node (400) comprising memory circuitry (401), processor circuitry (402), and a wireless interface (403), wherein the network node (400) is configured to:
   receive, from a wireless device, information indicative of a burst type; and
   transmit, to the wireless device, based on the information, control signalling indicative of an allocation of a configured resource for uplink transmission of a data burst.
42. The network node according to item 41, wherein the processor circuitry is configured to pre-configure, based on the burst type, a grant and/or a grant type for the uplink transmission.
43. The network node according to any of items 41-42, wherein control signalling indicative of the allocation of the configured resource for uplink transmission comprises control signalling indicative of a pre-configured grant.
44. The network node according to any of items 41-43, wherein the information indicative of the burst type comprises information indicative of a pattern in data bursts and/or of a shape of the data bursts.
45. The network node according to any of items 41-44, wherein the information indicative of the burst type comprises time information related to the data burst.
46. The network node according to item 45, wherein the time information is indicative of a periodicity of the data burst and/or of an order of the data burst.
47. The network node according to any of items 45-46, wherein the time information is indicative of a time adjustment parameter for adjusting a timing of the allocation of the configured resource at the network node.
48. The network node according to any of items 41-47, wherein the information indicative of the burst type comprises size information of the data burst.
49. The network node according to any of items 41-48, wherein the information indicative of the burst type comprises priority information between burst types and/or data packets.
50. The network node according to any of items 41-49, wherein the network node (400) is configured to receive, from the wireless device, an indicator indicative of a property of the data burst for uplink transmission.
51. The network node according to any of items 41-50, wherein the processor circuitry is configured to determine, based on the indicator, the allocation of the configured resource.
52. The network node according to any of items 41-51, wherein the data burst comprises a plurality of data packets, wherein the plurality of data packets is associated with a same group.
53. A wireless device (300) comprising memory circuitry (301), processor circuitry (302), and a wireless interface (303), wherein the wireless device (300) is configured to:
   transmit, to a network node, control information indicative of a time adjustment parameter for adjusting a timing of an allocation of a configured resource at the network node for uplink transmission of a data burst.
54. A network node (400) comprising memory circuitry (401), processor circuitry (402), and a wireless interface (403), wherein the network node (400) is configured to:
   receive, from a wireless device, control information indicative of a time adjustment parameter for adjusting, at the network node, a timing of an allocation of a configured resource, wherein the configured resource is for the uplink transmission of a data burst; and
   adjust, based on the control information, the timing of the allocation of the configured resource.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a wireless device, for uplink transmission of a data burst to a network node, the method comprising:
transmitting, to the network node, information indicative of a burst type; and
receiving, from the network node, control signalling indicative of an allocation of a configured resource for uplink transmission.

2. The method according to claim 1, wherein the information indicative of the burst type comprises information indicative of a pattern in data bursts and/or of a shape of the data bursts.

3. The method according to claim 1, the method comprising updating, based on a change in traffic conditions and/or in radio conditions, the information indicative of the burst type.

4. The method according to claim 1, wherein the information indicative of the burst type comprises time information related to the data burst and wherein the time information is indicative of a periodicity of the data burst and/or of an order of the data burst.

5. The method according to claim 4, wherein the time information is indicative of a time adjustment parameter for adjusting a timing of the allocation of the configured resource at the network node.

6. The method according to claim 1, wherein the information indicative of the burst type comprises size information of the data burst and wherein the size information of the data burst comprises a statistical parameter indicative of a size of the data burst and/or a change in the size of the data burst.

7. The method according to claim 1, the method comprising transmitting, to the network node, an indicator indicative of a property of the data burst for uplink transmission.

8. The method according to claim 1, wherein control signalling indicative of the allocation of the configured resource for uplink transmission is based on the burst type.

9. The method according to claim 1, wherein the control signalling indicative of the allocation of the configured resource for uplink transmission comprises control signalling indicative of a configured grant.

10. A method, performed by a network node, for resource allocation of a data burst in uplink transmission from a wireless device, the method comprising:
receiving, from the wireless device, information indicative of a burst type; and
transmitting, to the wireless device, based on the information, control signalling indicative of an allocation of a configured resource for uplink transmission.

11. The method according to claim 10, the method comprising pre-configuring, based on the burst type, a grant and/or a grant type for the uplink transmission.

12. The method according to claim 10, wherein control signalling indicative of the allocation of the configured resource for uplink transmission comprises control signalling indicative of a pre-configured grant.

13. The method according to claim 10, wherein the information indicative of the burst type comprises information indicative of a pattern in data bursts and/or of a shape of the data bursts.

14. The method according to claim 10, wherein the information indicative of the burst type comprises time information related to the data burst and wherein the time information is indicative of a periodicity of the data burst and/or of an order the data burst.

15. The method according to claim 14, wherein the time information is indicative of a time adjustment parameter for adjusting a timing of the allocation of the configured resource at the network node.

16. The method according to claim 10, wherein the information indicative of the burst type comprises size information of the data burst and/or priority information between burst types and/or data packets.

17. The method according to claim 10, the method comprising receiving (S206), from the wireless device, an indicator indicative of a property of the data burst for uplink transmission.

18. The method according to claim 10, the method comprising determining, based on the indicator, the allocation of the configured resource.

19. A method, performed by a wireless device, for uplink transmission of a data burst to a network node, wherein the data burst comprises a plurality of data packets, the method comprising:
transmitting, to the network node, control information indicative of a time adjustment parameter for adjusting a timing of an allocation of a configured resource at the network node.

20. (canceled)
